(19) United States
(12) Patent Application Publication
(10) Pub. No.: US 2013/0211898 A1
(43) Pub. Date: Aug. 15, 2013

(54) EXPENSE TRACKER

(71) Applicant: Adam Lee, Burlingame, CA (US)

(72) Inventor: Adam Lee, Burlingame, CA (US)

(73) Assignee: Boku, Inc., San Francisco, CA (US)

(21) Appl. No.: 13/397,014

(22) Filed: Feb. 15, 2012

(51) Int. Cl. G06Q 20/40; G06Q 30/02; G06Q 20/22

(52) U.S. Cl. 705/14.23; 705/39; 705/44

(57) ABSTRACT

The invention provides a computer-based method of managing electronic transactions. A plurality of consumer accounts is stored in a data store, each consumer account having a first consumer account identifier. A rule is stored in association the consumer account. A charge request is received over a network interface device, the charge request including a charge amount and a second consumer account identifier. A selected one of the consumer accounts is identified by associating one of the first consumer account identifiers with the second consumer account identifier. The rule of the selected consumer account is retrieved in response to receiving the charge request and an action is executed based on the rule.

### BACKGROUND OF THE INVENTION

1). Field of the Invention

This invention relates generally to a transactions network and to a method and system for managing electronic transactions.

2). Discussion of Related Art

A customer who visits a store often uses a point-of-sale instrument such as a bank card or a credit card to pay for an item or items that are being purchased. The point-of-sale instrument communicates with a point-of-sale device such as a credit card reader. The point-of-sale device forms part of a point-of-sale network that communicates a charge request to a merchant acquirer computer system and the merchant acquirer computer system routes the charge to credit card and issuer computer systems forming part of the point-of-sale network. The credit card and issuer computer systems may for example include a credit card account to which an amount recorded on the point-of-sale device can be charged if sufficient funds or credit are available. The credit card and issuer computer systems then return a confirmation through the merchant acquirer computer system to the point-of-sale device that the transaction is good, whereafter an operator of the point-of-sale device will allow the customer to leave the store with the item or items that are being purchased.

Electronic transactions can be conducted in a similar manner. In the case of electronic transactions, a user can enter details of a point-of-sale instrument into an interface. Once the details are received, a charge request can be transmitted to a merchant acquirer computer system, and then be processed in a similar manner.

### SUMMARY OF THE INVENTION

The invention provides computer system for managing electronic transactions, including a server computer system having a processor, a computer-readable medium connected to the processor, a network interface device connected to the processor and a set of instructions on the computer-readable medium, the set of instructions being executable by the processor and further including a data store, a plurality of consumer accounts stored in the data store, each consumer account having a first consumer account identifier, a rule stored in association the consumer account, a communication and routing module that receives a charge request over the network interface device, the charge request including an charge amount and a second consumer account identifier and identifies a selected one of the consumer accounts by associating one of the first consumer account identifiers with the second consumer account identifier, and a rule application engine that retrieves the rule of the selected consumer account in response to receiving the charge request, and executes an action based on the rule.

The invention also provides a computer-based method of managing electronic transactions, including storing, with a processor, a plurality of consumer accounts in a data store, each consumer account having a first consumer account identifier, storing a rule in association the consumer account, receiving, with the processor, a charge request over the network interface device, the charge request including a charge amount and a second consumer account identifier, identifying, with the processor, a selected one of the consumer accounts by associating one of the first consumer account identifiers with the second consumer account identifier, retrieving, with the processor, the rule of the selected consumer account in response to receiving the charge request, and executing, with the processor, an action based on the rule.

### BRIEF DESCRIPTION OF THE DRAWINGS

The invention is further described by way of example with reference to the accompanying drawings, wherein:

FIG. 1 is a block diagram of a transactions network according to an embodiment of the invention;

FIG. 2 is a block diagram of a mobile device forming part of the transactions network;

FIG. 3 is a block diagram of a consumer account setup module, consumer account management system, consumer account and consumer account funding infrastructure forming part of the transactions network;

FIG. 4A is a block diagram of a view that is displayed in an interface of the mobile device to prompt a consumer to register a consumer account or to log into an existing account;

FIGS. 4B and 4C are views similar to FIG. 4A wherein the consumer registers a new account;

FIGS. 4D and 4E are views similar to FIG. 4A wherein the consumer logs into an existing consumer account;

FIGS. 5A and 5B are views similar to FIG. 4A wherein the consumer registers and stores funding sources for the consumer account;

FIGS. 6A and 6B are views wherein the consumer uses the mobile device to store a ceiling value to which the consumer account is periodically replenished;

FIG. 7 is a block diagram of a merchant account, a merchant account management system, a merchant computer system, in a merchant account payment infrastructure forming part of the transactions network;

FIG. 8A is a screenshot that appears within a browser of the merchant computer system for the merchant to log into the account;

FIG. 8B is a view similar to FIG. 8A permitting the merchant to enter initial details of a voucher, including a discount amount and start and end date;

FIG. 8C is a view similar to FIG. 8B where the merchant can upload a voucher image;

FIG. 8D is a view similar to FIG. 8C where the merchant can select specific terminals or groups of terminals where the offer will be valid;

FIG. 8E is a view similar to FIG. 8D where the merchant can view the offer before approving the offer;

FIG. 8F is a view similar to FIG. 8E after the offer has been approved by the merchant;

FIG. 8G is a view similar to FIG. 8F displaying multiple campaigns based on the merchant account;

FIG. 9 is a block diagram illustrating multiple merchant accounts and a voucher management system for purposes of managing transactions based on voucher entries;

FIG. 10 is a view that is displayed in the mobile device after a consumer has logged the mobile device into a particular consumer account;

FIGS. 11A and 11B are views that are displayed to the consumer of vouchers and specifics of vouchers, respectively;

FIG. 12 is a block diagram illustrating a point-of-sale instrument, a point-of-sale network, and a transaction clearing system of the transactions network;

FIG. 13 is a block diagram illustrating the consumer account and other components of preceding drawings that are used for processing a transaction against the consumer account;

FIGS. 14A, 14B and 14C illustrate notifications that are displayed on the interface of the mobile device after a transaction has been processed, a stored value has been reduced, and a discount has been applied;

FIG. 15 is a view similar to FIG. 10 after a number of transactions have been processed;

FIG. 16 is a view that is displayed in the mobile device of transactions for which the account has been used;

FIG. 17 is a view similar to FIG. 16 of categories of transactions;

FIG. 18 is a view similar to FIG. 17 of one category of transactions;

FIG. 19 is a view that is displayed for the consumer to set a budget for the category of FIG. 17;

FIG. 20 is a view that is displayed to the consumer to select certain actions to be taken based on the budget and when a transaction is being processed or has been processed;

FIG. 21 is a view similar to FIG. 15 wherein another budget category has been added for another category;

FIG. 22 is a view similar to FIG. 19 wherein a further budget is created for a further category;

FIG. 23 is a view similar to FIG. 21 further illustrating the creation of additional budget categories;

FIGS. 24 and 25 are notifications that are displayed within the interface of the mobile device, respectively, showing a notification and a declined transaction based on the budgets that have been created;

FIG. 26 is a view similar to FIG. 23 after further transactions have been processed;

FIG. 27 is a view similar to FIG. 26 after the stored value has been replenished to the ceiling value and the budgets have been reset;

FIG. 28 is flowchart showing the execution of rules forming part of a consumer account;

FIG. 29 is a block diagram of a machine in the form of a computer system forming part of the transactions network; and

FIG. 30 is a block diagram of the mobile device illustrating SmartPhone features thereof.

### DETAILED DESCRIPTION OF THE INVENTION

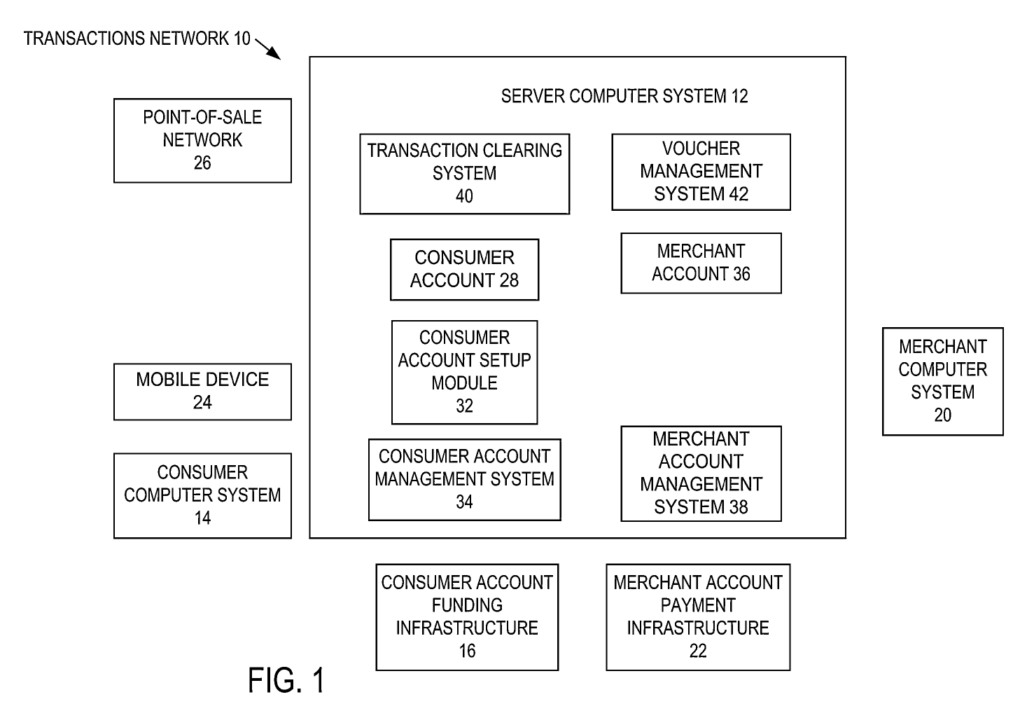

FIG. 1 of the accompanying drawings illustrates a transactions network 10, according to an embodiment of the invention, including a server computer system 12, a consumer computer system 14, a consumer account funding infrastructure 16, a merchant computer system 20, a merchant account payment infrastructure 22, a mobile device 24, and a point-of-sale network 26.

The server computer system 12 includes a plurality of consumer accounts (only one consumer account 28 shown), a consumer account setup module 32, a consumer account management system 34, a plurality of merchant accounts (only one merchant account 36 shown), a merchant account management system 38, a transaction clearing system 40, and a voucher management system 42.

### 1). Mobile Application

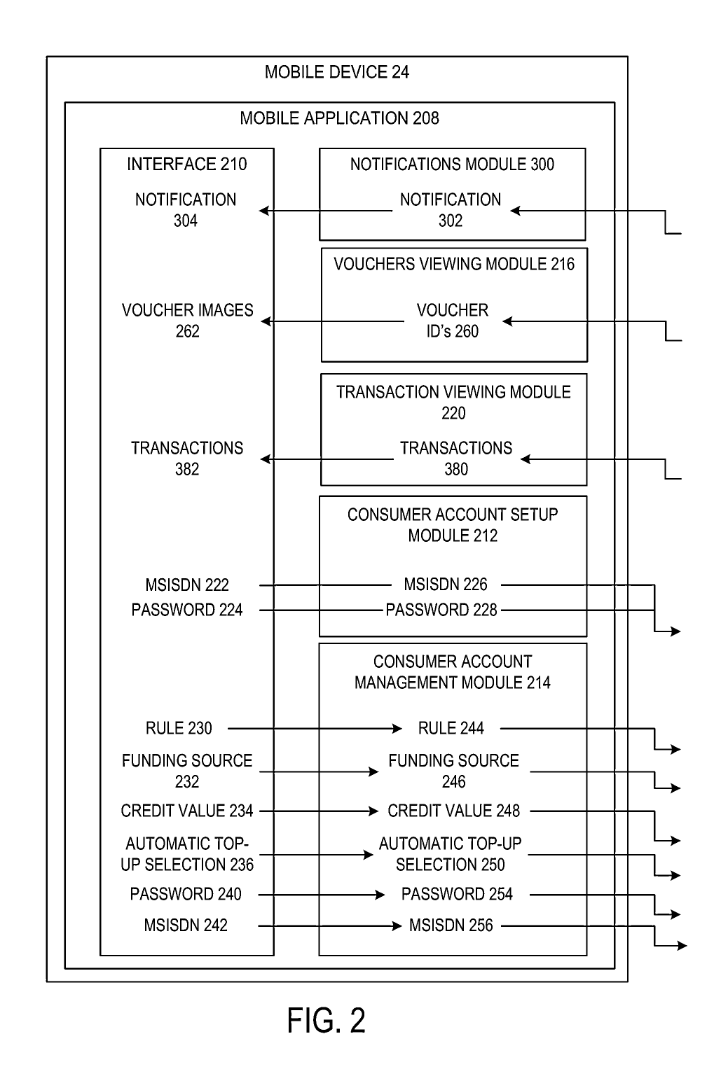

As shown in FIG. 2, the mobile device 24 includes a mobile application 208. The mobile application 208 has an interface 210, a consumer account setup module 212, a consumer account management module 214, a vouchers viewing module 216, a notifications module 218, and a transaction viewing module 220.

### 2). Consumer Accounts

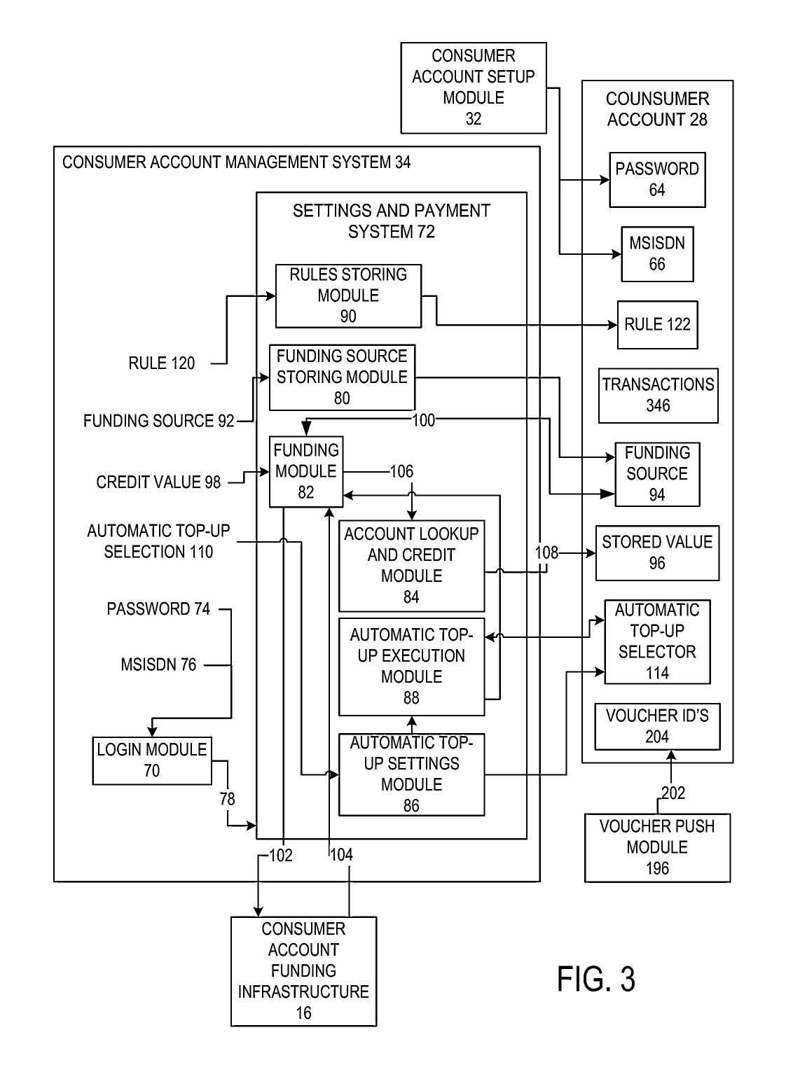

When the mobile application 208 is initially downloaded onto the mobile device 24, a consumer is provided access to the consumer account setup module 212. The consumer can enter a Mobile Subscriber Integrated Services Digital Network Number (MSISDN) 222 and a password 224 into the interface 210. The MSISDN 222 and the password 224 are received as a MSISDN 226 and a password 228 within the consumer account setup module 212 and are transmitted by the consumer account setup module 212 in FIG. 2 to the consumer account setup module 32 in FIG. 3.

Referring now to FIG. 3, the consumer account setup module 32 then establishes one consumer account 28 with a password 64 corresponding to the password 228 in FIG. 2 and a MSISDN 66 corresponding to the MSISDN 228 in FIG. 2. The MSISDN 66 serves as a consumer account identifier for the respective consumer account 28. Each consumer account 28 will therefore have a different MSISDN 66.

The consumer account management system 34 includes a login module 70, and a settings and payment system 72. A consumer at the mobile device 24 in FIG. 2 can enter a password 240 and a MSISDN 242 into the interface 210. The password 240 and the MSISDN 242 are received as a password 254 and a MSISDN 256 in the consumer account management module 214, and are transmitted from the mobile device 24 and are received by the login module 70 in FIG. 3 as a password 74 and a MSISDN 76 respectively. The login module 70 then compares the password 74 with the password 64 of the consumer account 28 and compares the MSISDN 76 with the MSISDN 66 of the consumer account 28. Upon a favorable comparison of the passwords 74 and 64 and the MSISDN's 76 and 66, the login module 70 at 78 then authorizes access to the functionality of the settings and payment system 72 for the consumer account 28 having the respective MSISDN 66 corresponding to the MSISDN 76. The authorization 78 is thus not provided to the mobile device 24 upon an unfavorable login through the login module 70.

The settings and payment system 72 includes a funding source storing module 80, a funding module 82, an account lookup and credit module 84, an automatic top-up settings module 86, an automatic top-up execution module 88, and a rules storing module 90.

The consumer account management module 214 of the mobile application 208 in FIG. 2 allows for entry of a rule 230, a funding source 232, a credit value 234, an automatic top-up selection 236, a password 240, and an MSISDN 242 into the interface 210 and are respectively received by the consumer account management module 214 as a rule 244, funding source 246, credit value 248, automatic top-up selection 250, password 254 and MSISDN 256, and are then provided to the consumer account management system 34 in FIG. 3.

The funding source 246 in FIG. 2 is entered as a funding source 92 into the settings and payment system 72. The funding source storing module 80 then stores the funding source 92 as a funding source 94 within the consumer account 28 having the appropriate MSISDN 66. The consumer account 28 also has a stored value 96 that is initially set at $0. Should the consumer at the mobile device 24 in FIG. 2 wish to increase the stored value 96, the consumer enters the credit value 234 resulting in entry of a corresponding credit value 98 into the settings and payment system 72 of FIG. 3. The funding module 82 receives the credit value 98. The credit value 98 may for example be for $40.00. At 100, the funding module 82 retrieves the funding source 94 and the MSISDN 66 from the consumer account 28. At 102, the funding module 82 communicates with the consumer account funding infrastructure 16 by transmitting a funding request. The consumer account funding infrastructure 16 may for example include a bank account number. The funding source 92 includes routing information for the bank account number. At 102, the funding module 82 thus uses the routing information of the funding source 92 to reach the respective bank account number in the consumer account funding infrastructure 16. At 102, the respective credit value 98, in the present example $40.00, is also transmitted to the consumer account funding infrastructure 16. The signal transmitted at 102 also includes an IP address of the server computer system 12 for purposes of return communication.

The consumer account infrastructure 16 then makes a determination whether sufficient funds are available within the consumer account funding infrastructure 16 to allow for a transfer of the credit value 98. At 104, the consumer account funding infrastructure 16 utilizes the IP address received at 102 to transmit a top-up confirmation to the funding module 82. A top-up confirmation is only transmitted if sufficient funds are available within the consumer account funding infrastructure 16 to cover the credit value 98. If insufficient funds are available within the consumer account funding infrastructure 16, then no top-up confirmation will be transmitted at 104 and a decline signal will instead be transmitted to the funding module 82.

If a decline signal is received by the funding module 82 from the consumer account funding infrastructure 16, the funding module 82 transmits a message to the mobile device 24 in FIG. 2 to indicate that the stored value 96 in FIG. 3 will not be increased. If the top-up confirmation 104 is received by the funding module 82, the funding module 82 at 106 then transmits the MSISDN 66 received at 100 and the credit value 98 to the account lookup and credit module 84. The account lookup and credit module 84 then, at 108, utilizes the MSISDN 66 to access the respective consumer account 28 and increases the stored value 96 by the credit value 98. In the present example the stored value 96 is thus increased from $0 to $40.00.

The consumer at the mobile device 24 in FIG. 2 may also enter an automatic top-up selection 236 which is received as an automatic top-up selection 110 into the settings and payment system 72 in FIG. 3. The automatic top-up settings module 86 then stores the automatic top-up selection 110 as an automatic top-up selector 114 in the consumer account 28. The automatic top-up selector 114 indicates whether an automatic top-up should be performed, or not, based on the automatic top-up selection 110. The automatic top-up selector 114 also includes a ceiling value to which the consumer wants to increase the stored value 96. Simply setting the ceiling value will set the indication to automatically top up from “OFF” to “ON.”

The automatic top-up execution module 88 periodically, e.g. daily, reads the automatic top-up selector 114. The automatic top-up execution module 88 only executes the funding module 82 if the automatic top-up selector 114 is set to an “ON” status for automatic top-up, and if other limits have been reached such as the end of a one-month period has been reached and the stored value 96 is below the ceiling value. The automatic top-up execution module 88 therefore does not execute the funding module 82 if either the automatic top-up selector 114 is set to “OFF” indicating no automatic top-up, or if such other limits have both been reached.

When the automatic top-up execution module 88 executes the funding module 82, the automatic top-up execution module 88 transmits a credit value 98 to the funding module 82 and the funding module 82 then transmits the credit value 98 in the funding request 102 to the consumer account funding infrastructure 16. The credit value 98 may for example be the difference between the stored value 96 and the ceiling value. Upon a favorable top-up confirmation 104, the funding module 82 then automatically transmits the MSISDN 66 and a credit value 98 at 106 to the account lookup and credit module 84 for increasing the stored value 96 by the credit value 98. The stored value 96 is thus automatically updated based on the automatic top-up selector 114.

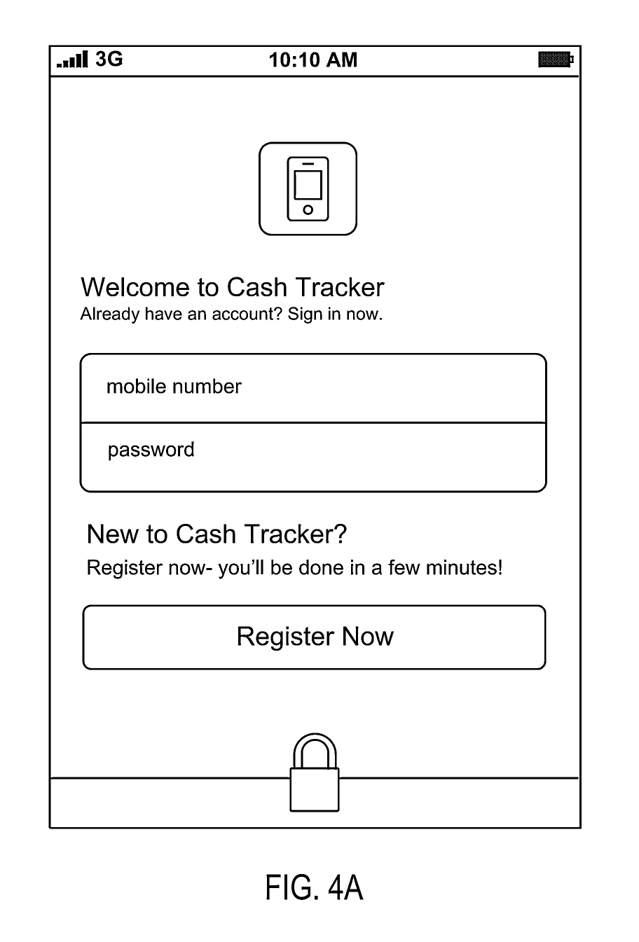

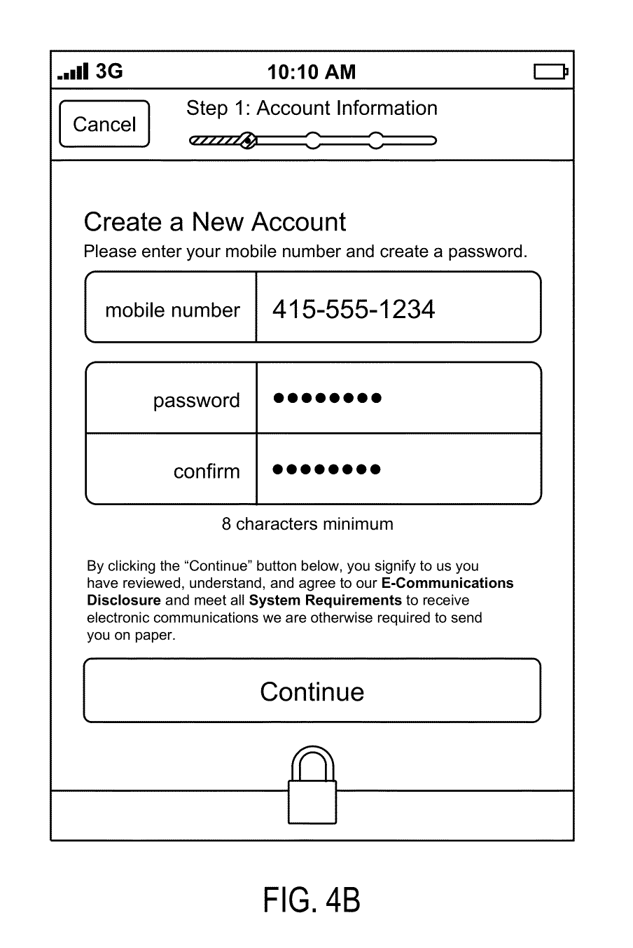

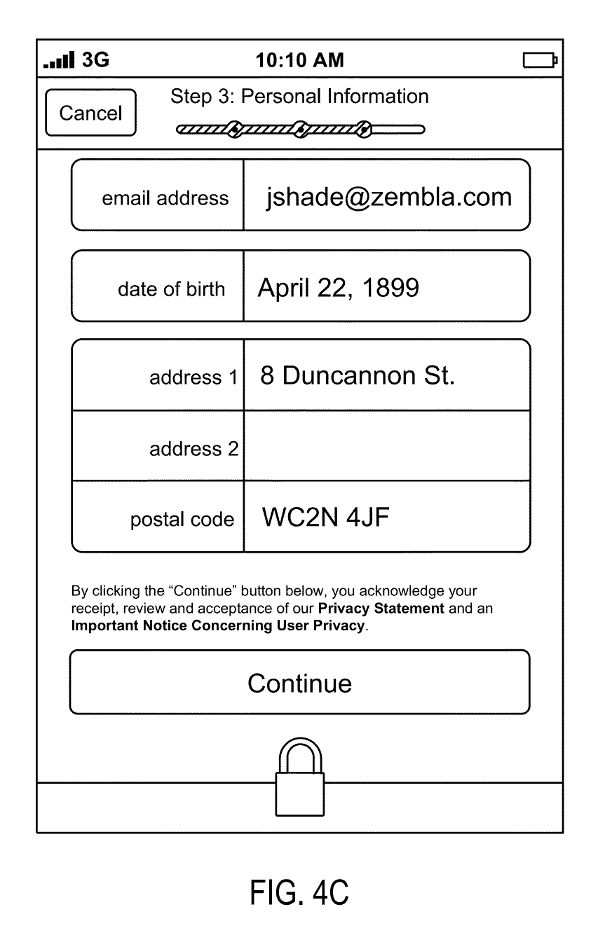

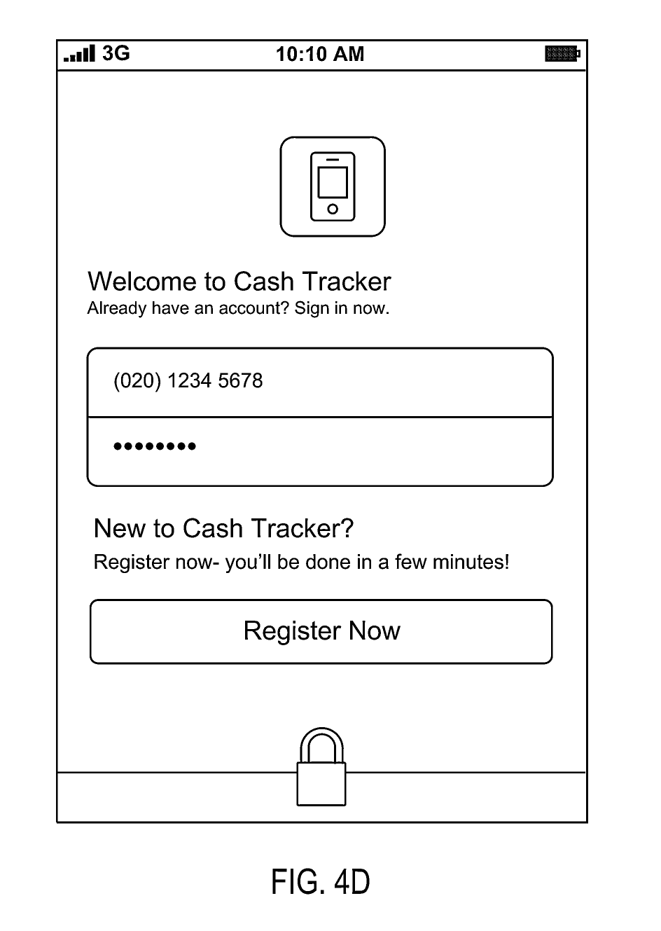

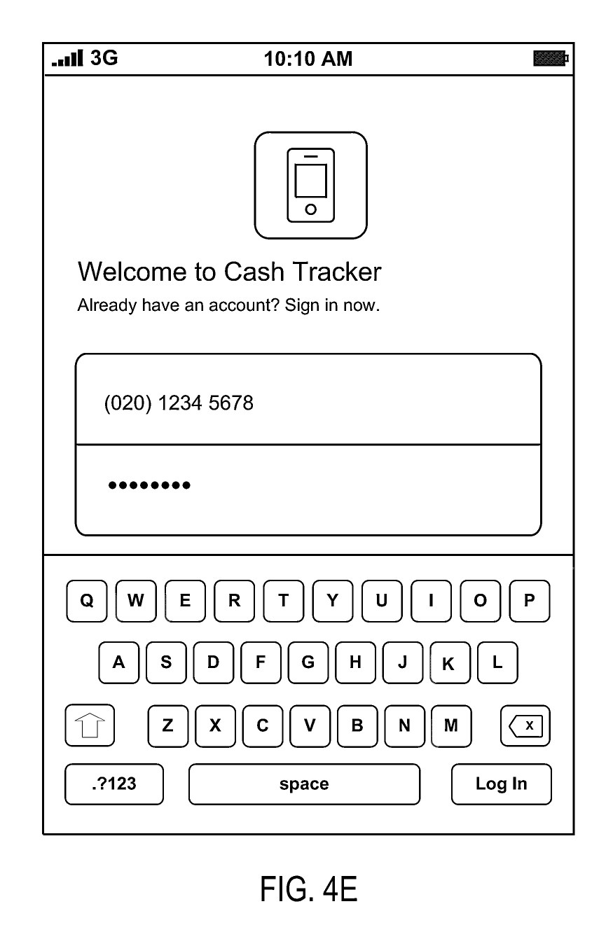

FIG. 4A illustrates a screenshot on the Interface 210 in FIG. 2 when the consumer first opens the mobile application 208 and is given an option to either login or create a new account. FIG. 4B is a view similar to FIG. 4A when the consumer first establishes an account using the consumer account setup module 212 in FIG. 2. FIG. 4C is a view similar to FIG. 4B for the consumer to enter further details of the account.

FIGS. 4D and 4E are views that are displayed on the interface 210 in FIG. 2 when the consumer uses the consumer account management module 214 to enter the password 240 and the MSISDN 242 in FIG. 2 in order to log into the respective consumer account 28 in FIG. 3.

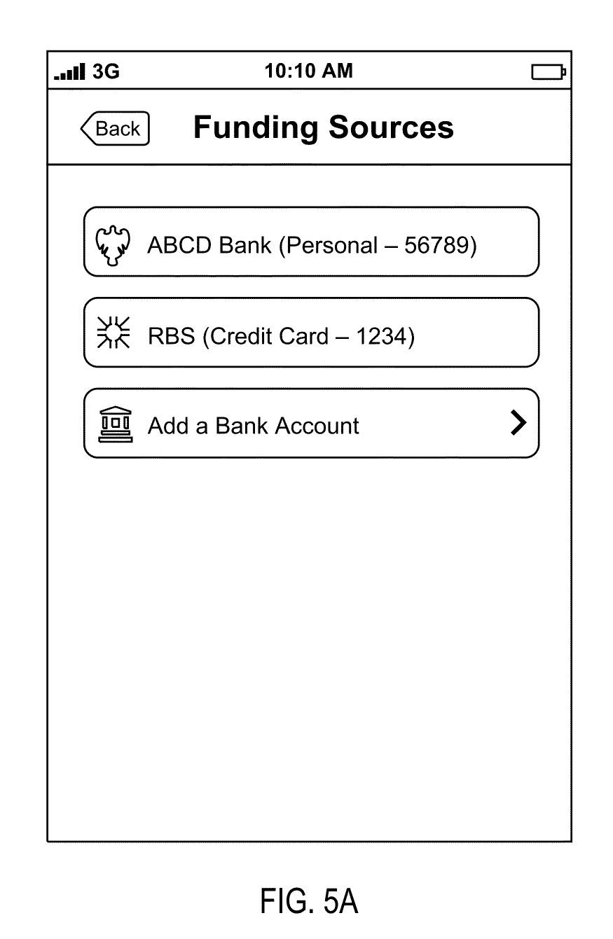

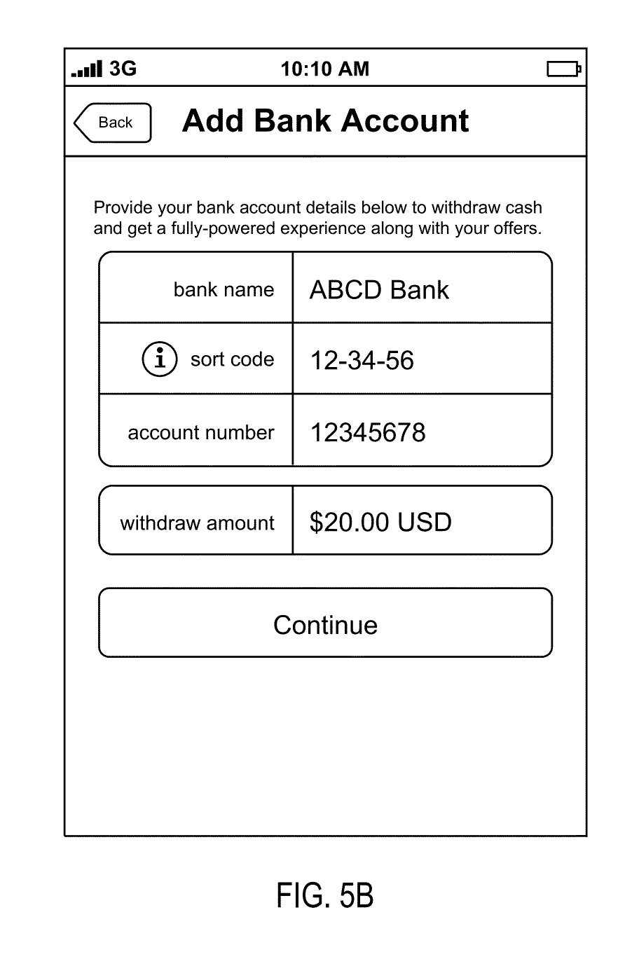

In FIG. 5A the funding sources that have been established by the consumer are displayed. FIG. 5B is a view that allows for the consumer to add a funding source such as the funding source 232 in FIG. 2.

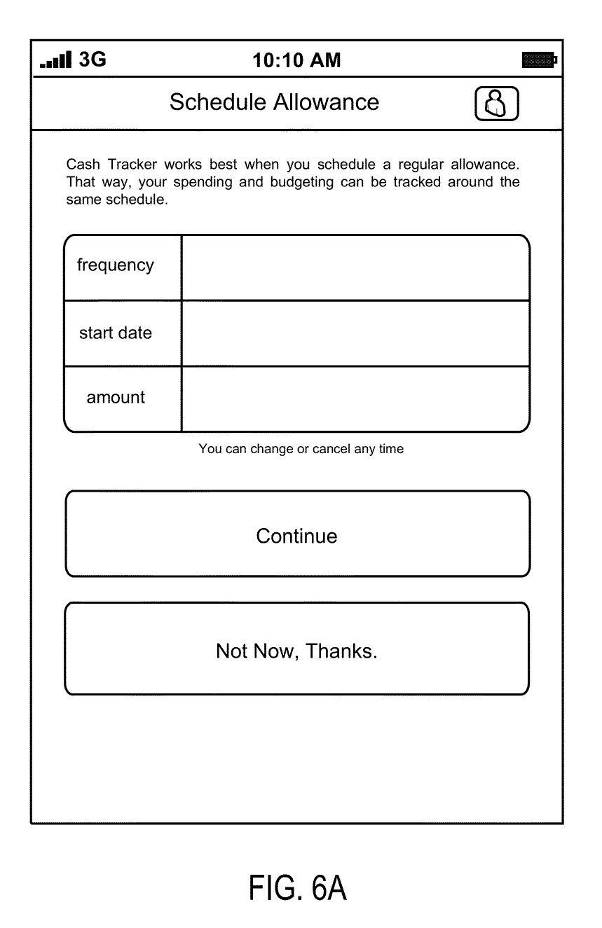

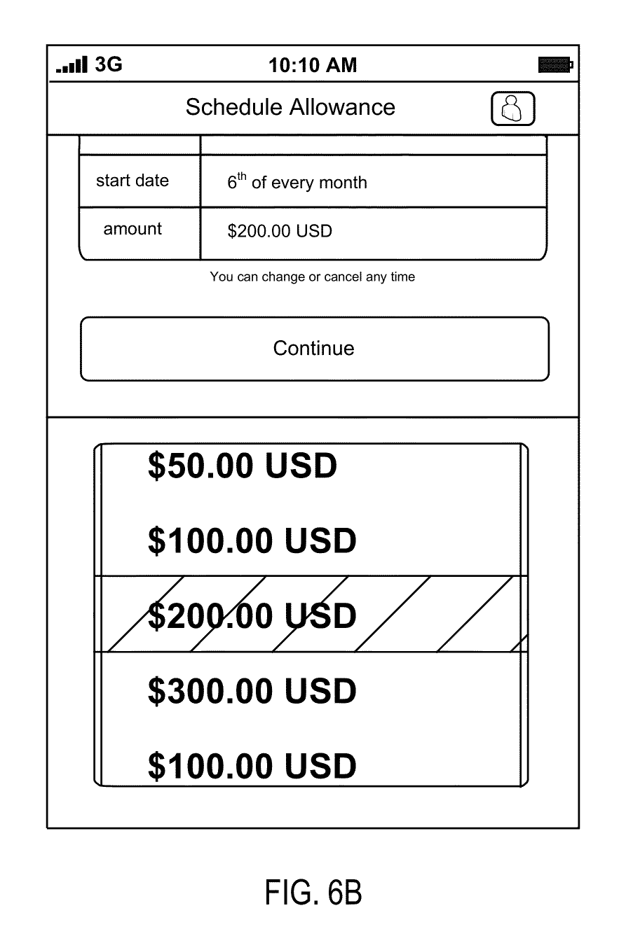

FIG. 6A is a view that is displayed to allow the consumer to select the automatic top-up selection 236 in FIG. 2. In FIG. 6B, the consumer is given the option to select the ceiling value to which the stored value should be replenished.

### 3). Merchant Offers

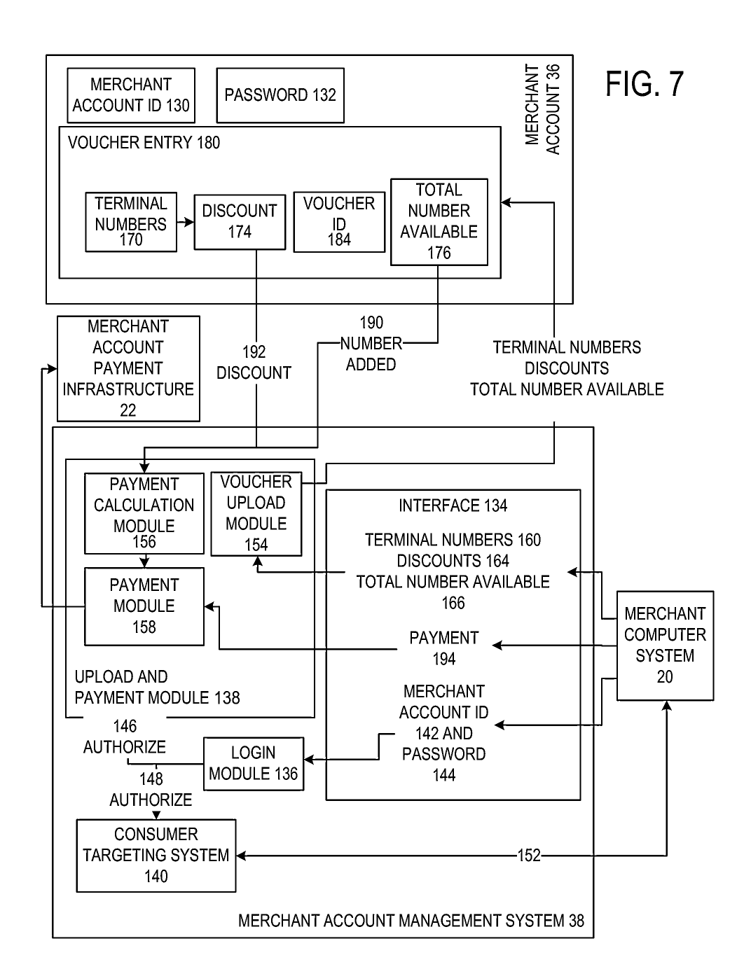

As shown in FIG. 7, the merchant account 36 in FIG. 1 is established by assigning a merchant account identifier (ID) 130 and a password 132. Each merchant account 36 will thus have a different merchant account ID 130.

The merchant account management system 38 includes an interface 134, a login module 136, an upload and payment module 138, and a consumer targeting system 140.

A merchant at the merchant computer system 20 can login to the merchant account 36 by downloading the interface 134 and entering a merchant account ID 142 and a password 144 via the interface 134 into the merchant account management system 38. The login module 136 then compares the merchant account ID 142 and the password 144 with the merchant account ID 130 and password 132 to identify and provide access to the respective merchant account 36. The login module 136 then at 146 authorizes access to the upload and payment module 138 by the merchant computer system 20 only for purposes of the respective merchant account 36 having the merchant account ID 130 matching the merchant account ID 142. At 148, the login module 136 similarly authorizes access to the consumer targeting system 140 by the merchant computer system 20.

The consumer targeting system 140 receives data from the consumer account 28 in FIG. 3 and all other consumer accounts. At 152, the merchant computer system 20 accesses the data received by the consumer targeting system 140. A merchant at the merchant computer system 20 can then selectively target a specific consumer account 28 or groups of consumer accounts based on the data received by the consumer targeting system 140. Table 1 illustrates selective targeting by select merchants.

TABLE 1

| | | Merchant | |
|---|---|---|---|
| | Merchant Account 1 | Account 2 | Merchant Account 3 |
| Consumer | Selective targeting | No selective | Selective targeting |
| Account 1 | | targeting | |
| Consumer | Selective targeting | No selective | Selective targeting |
| Account 2 | | targeting | |
| Consumer | Selective targeting | No selective | Selective targeting |
| Account 3 | | targeting | |

The upload and payment module 138 includes a voucher upload module 154, a payment calculation module 156, and a payment module 158. A merchant at the merchant computer system 20 uses the interface 134 to enter voucher information, including terminal numbers 160, discounts 164 and the total number available 166. The voucher upload module 154 then stores a respective voucher entry 168 in or associated with the merchant account 36 having the merchant account ID 130. The voucher entry 168 includes terminal numbers 170 corresponding to the terminal numbers 160, a discount 174 corresponding to one of the discounts 164, and a total number available 176 corresponding to the total number available 166. By way of example, the terminal numbers 170 may be terminals 2 and 5, the discount 174 may be 50 cents and the total number available 176 may be 60.

Similarly, additional voucher entries can be entered from the merchant computer system 20 through the interface 134 and the voucher upload module 154. Each voucher entry has a respective data set for terminal numbers 170, a discount 174 and the total number available 176. Each voucher entry also has a respective voucher ID 184.

Once the voucher entry 168 has been uploaded into the merchant account 36, the payment calculation module 156 calculates a payment to be made based on the voucher entry 168. In the example, it is assumed that the voucher entry 168 was pre-existing with a certain number, for example 20 as the total number available. The payment calculation module 156 at 190 receives or calculates the number added to the total number available 176. In the present example, the total number available 176 has increased from 20 to 60, such that the number added is 40. The payment calculation module 156 at 192 also receives the discount 174. The payment calculation module 156 then multiplies the number added by the discount 174. In the present example, the number added is 40 and the discount is 50 cents, which results in a payment of $20.

The payment calculation module 156 then submits the $20 charge to the payment module 158. The merchant then enters a payment 194 into the interface 134, which is received by the payment module 158. The payment module 158 communicates with the merchant account payment infrastructure 22 by submitting a charge request and receiving a confirmation to either allow or deny the charge request. In another example, the merchant account 36 may have a stored value 96 that can be updated from a funding source and the payment module 158 can decrement the stored value 96 by entering a debit against the stored value 96.

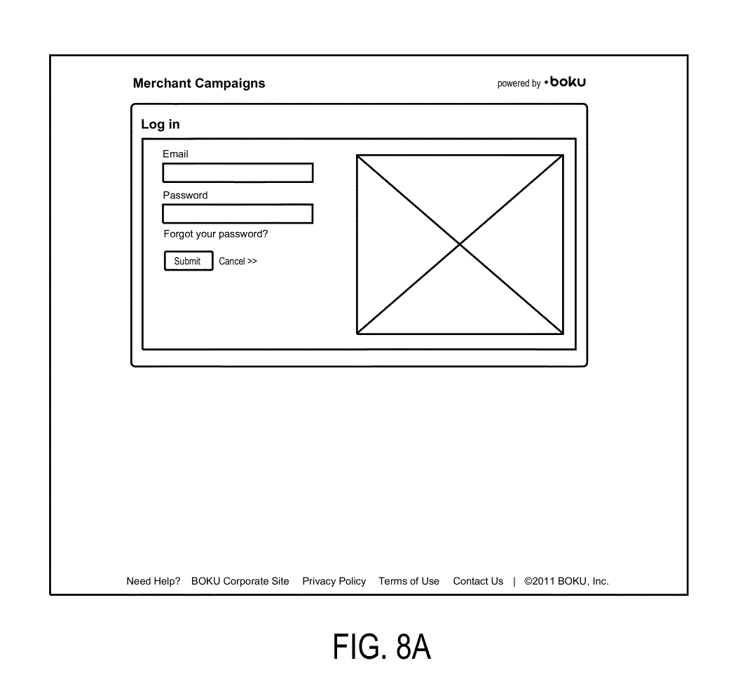

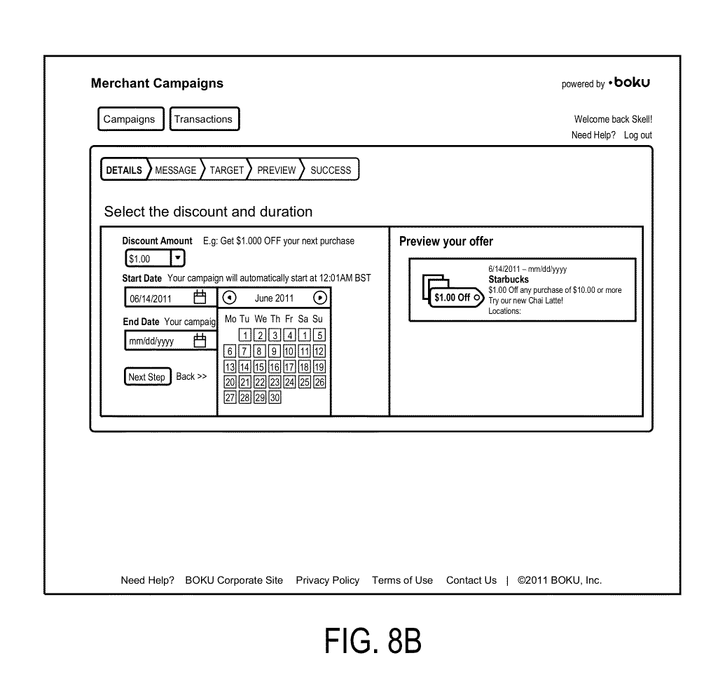

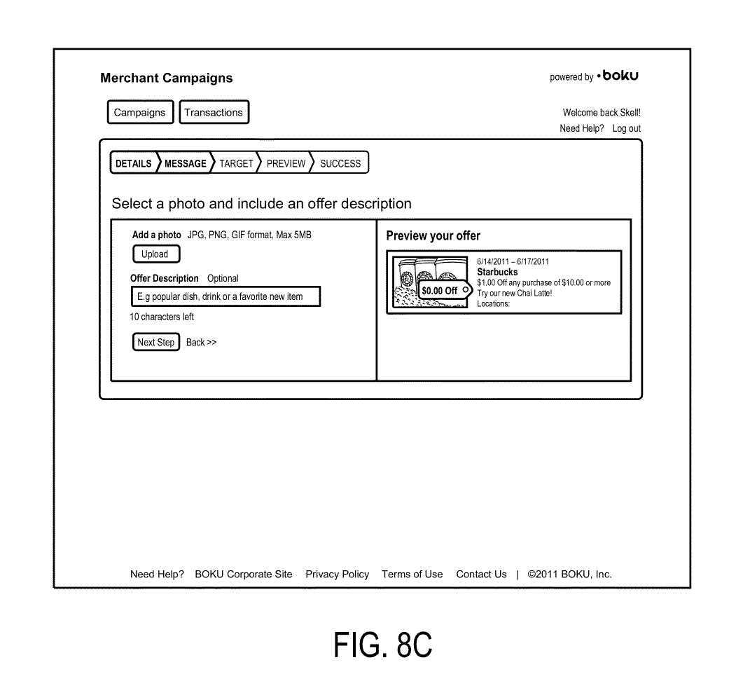

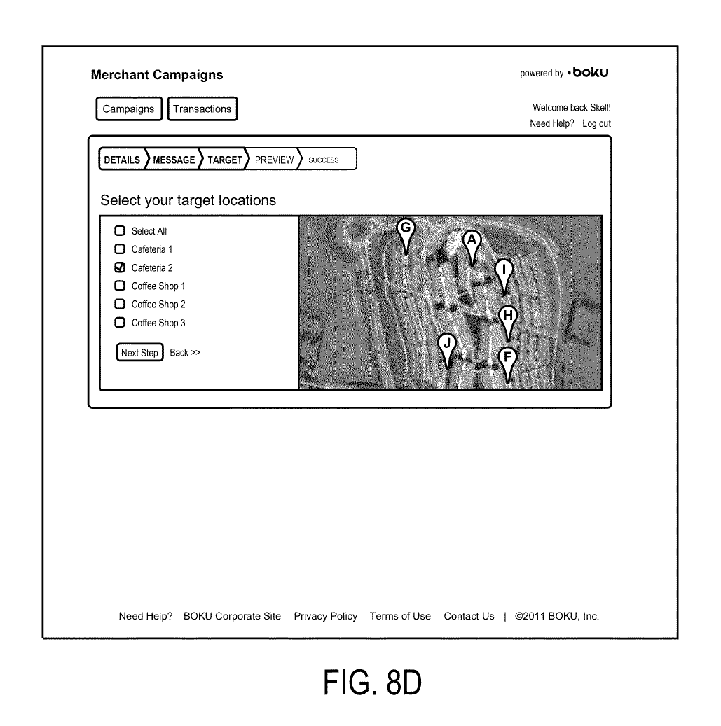

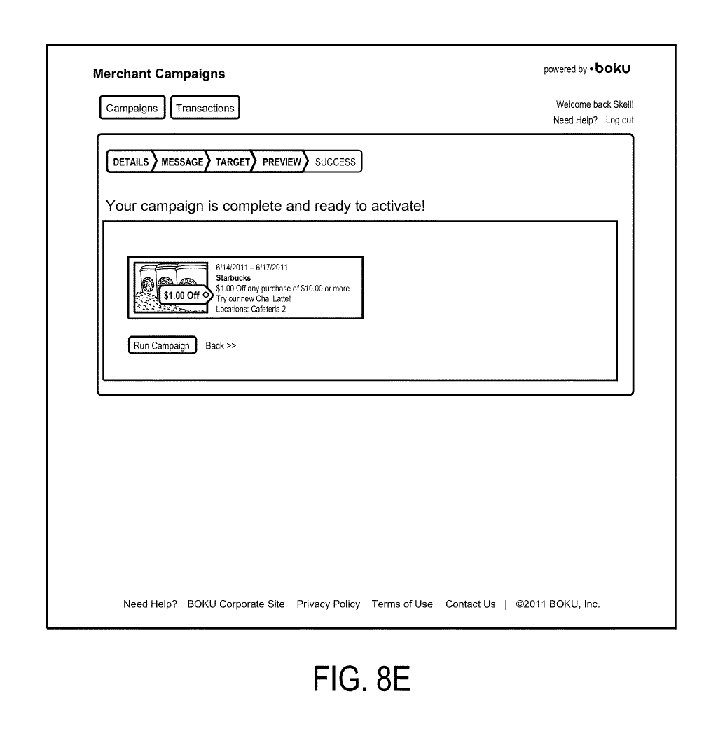

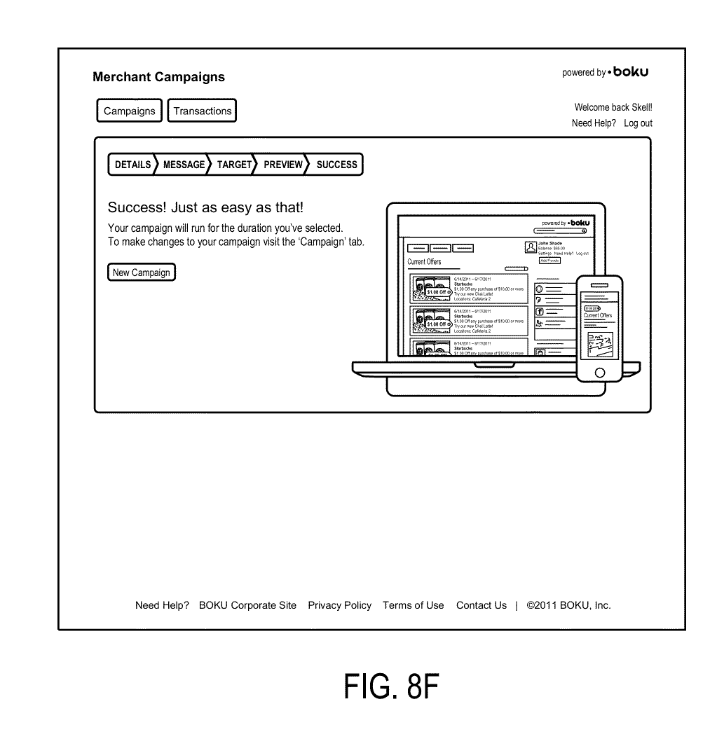

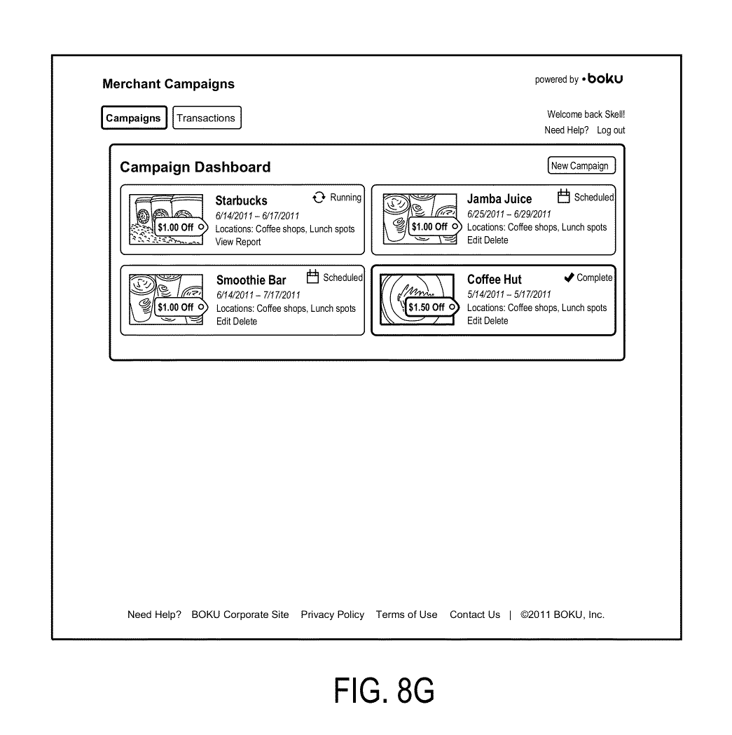

FIG. 8A illustrates a screenshot that appears in the interface 134 when viewed within a browser window of a browser application at the merchant computer system 20 in FIG. 7. The merchant logs in using an email and a password.

FIG. 8B illustrates a screenshot that is displayed at the merchant computer system 20 after login and when a merchant begins to enter details of an offer. The interface 134 allows for entry of a discount (“Discount Amount”) and start and end dates of the offer. A preview of the offer is also displayed.

In FIG. 8C the merchant is given an opportunity to upload a photo or other image of the offer. The photo or image will then be displayed within the respective voucher entry, e.g. the voucher entry 168 in FIG. 7. The photo or image can be uploaded from the merchant computer system 20 or from another location on a network.

In FIG. 8D the merchant is given an opportunity to restrict the offer to certain locations, while excluding other locations.

In FIG. 8E the merchant is given an opportunity to preview the offer as it will appear before approving the offer. The merchant then selects a button “Run Campaign” to approve the offer.

FIG. 8F is a screenshot displaying to the merchant that the offer is successful. The consumer can then select a button “Campaigns.”

FIG. 8G illustrates a screenshot that is subsequently displayed to the merchant, illustrating the offer that has just been approved by the merchant and all other offers that are scheduled, completed or presently running based on the respective merchant account having the merchant account ID 130 in FIG. 7.

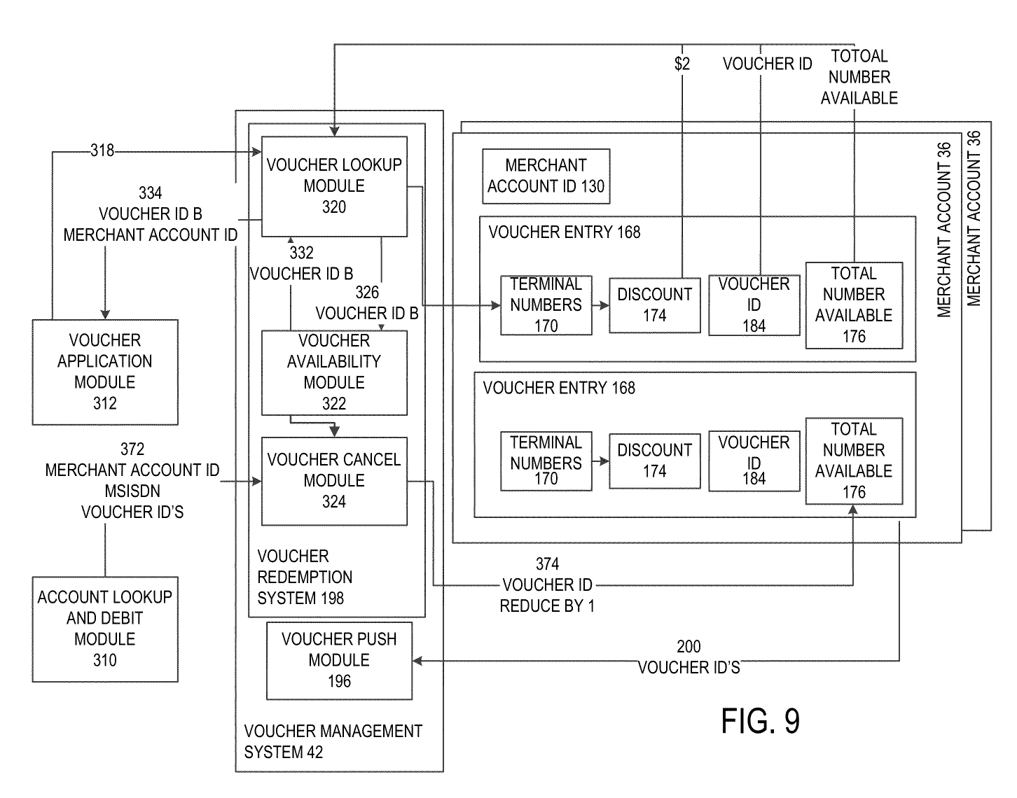

As shown in FIG. 9, the voucher management system 42 includes a voucher push module 196 and a voucher redemption system 198.

The voucher push module 196 at 200 receives all the voucher ID's 184 of the voucher entries. Referring again to FIG. 3, the voucher push module 196 at 202 then enters the voucher ID's 184 as voucher ID's 204 in the consumer account 28 and all other consumer accounts that have been targeted by a merchant. As such, merchant offers in the form of voucher ID's are associated with one of the consumer accounts 28 having a MSISDN 66 as a consumer account ID. The merchant offers in the form of the voucher ID's 204 can then be further processed based on the association of the voucher ID's 204 with the MSISDN 66 of the respective consumer account 28. In particular, the voucher ID's 204 can be transmitted to a mobile device 24 and be received by a mobile application that has been logged into the respective consumer account 28 by way of an identifier of the consumer account 28 having the MSISDN 66 as a consumer account identifier.

Referring again to FIG. 2, following login of the mobile application 208 into the consumer account 28 of FIG. 3, the vouchers viewing module 216 is accessible by a consumer operating the mobile device 24. The consumer then directs the vouchers viewing module 216 to download the voucher ID's 204 from the consumer account 28 in FIG. 3 as voucher ID's 260 received by the vouchers viewing module 216 in FIG. 2. Each voucher ID 260 has an associated image and the images are collectively displayed as voucher images 262 within the interface 210. Each voucher entry 168 within the merchant account 36 of FIG. 7 may for example have a respective voucher image and the voucher images are separately downloaded by the vouchers viewing module 216 of FIG. 2 based on the voucher ID's 260. What is important to note however, is that the voucher ID's 260 and the voucher images 262 are transmitted by the server computer system 12 in FIG. 1 and are received by the mobile device 24 based on a matching of the MSISDN 256 transmitted by the mobile application 208 and the MSISDN 66 of the respective consumer account 28.

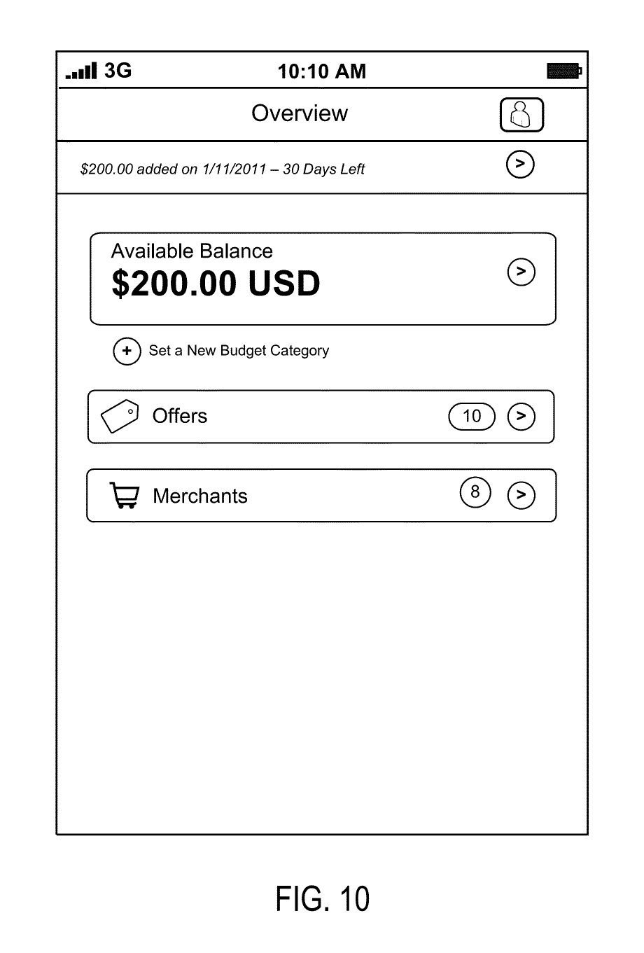

FIG. 10 is a home screen after login of the mobile application 208 in FIG. 2 where the stored value 96 is displayed. The home screen also includes links for setting a new budget category, for viewing offers and merchants.

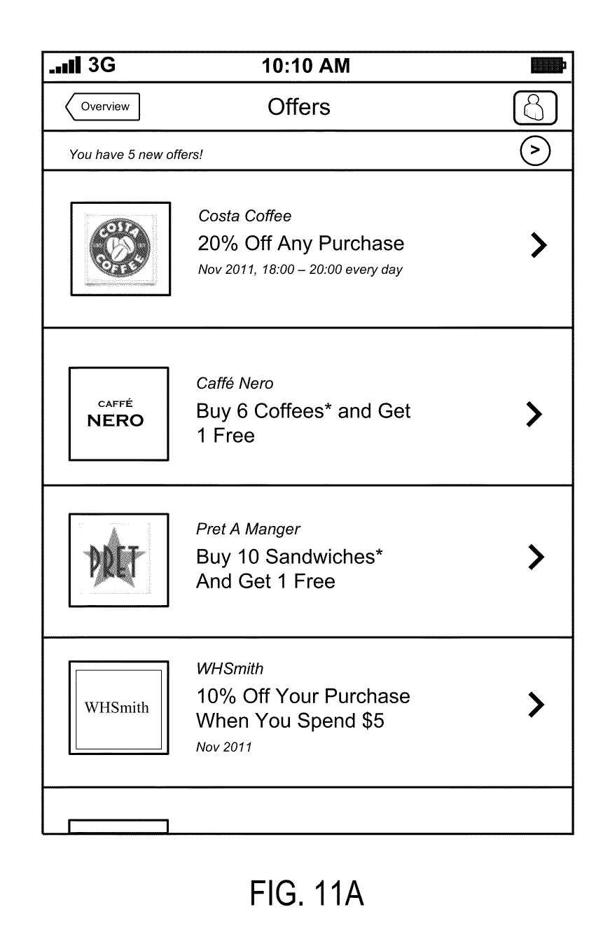

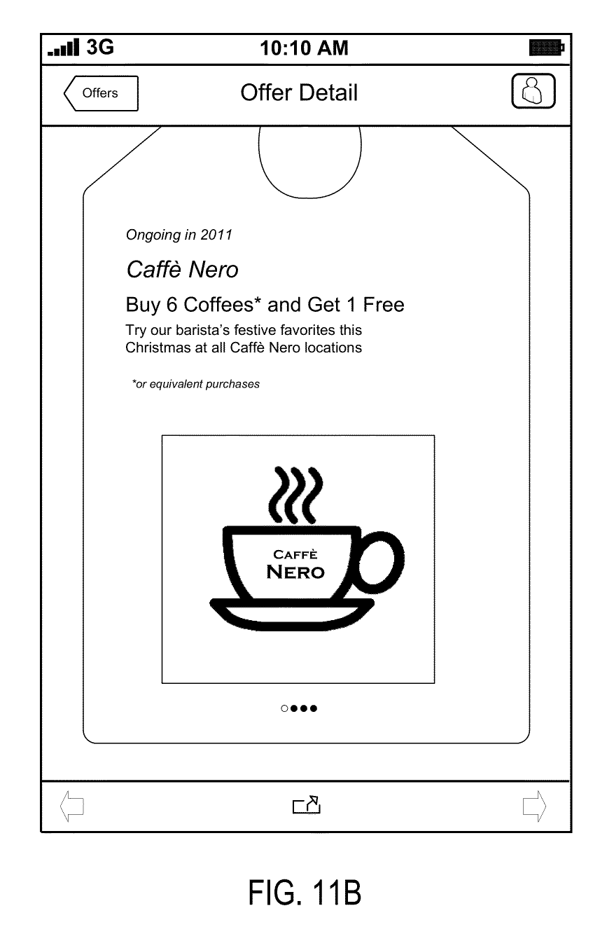

FIG. 11A illustrates a plurality of voucher images such as the voucher images 262 in FIG. 2 that are displayed after the consumer selects “Offer” in FIG. 10. The consumer can select any one of the vouchers to obtain more information about the voucher and the offer.

FIG. 11B is a view that is displayed showing more information about one of the vouchers.

### 4). Transaction Processing

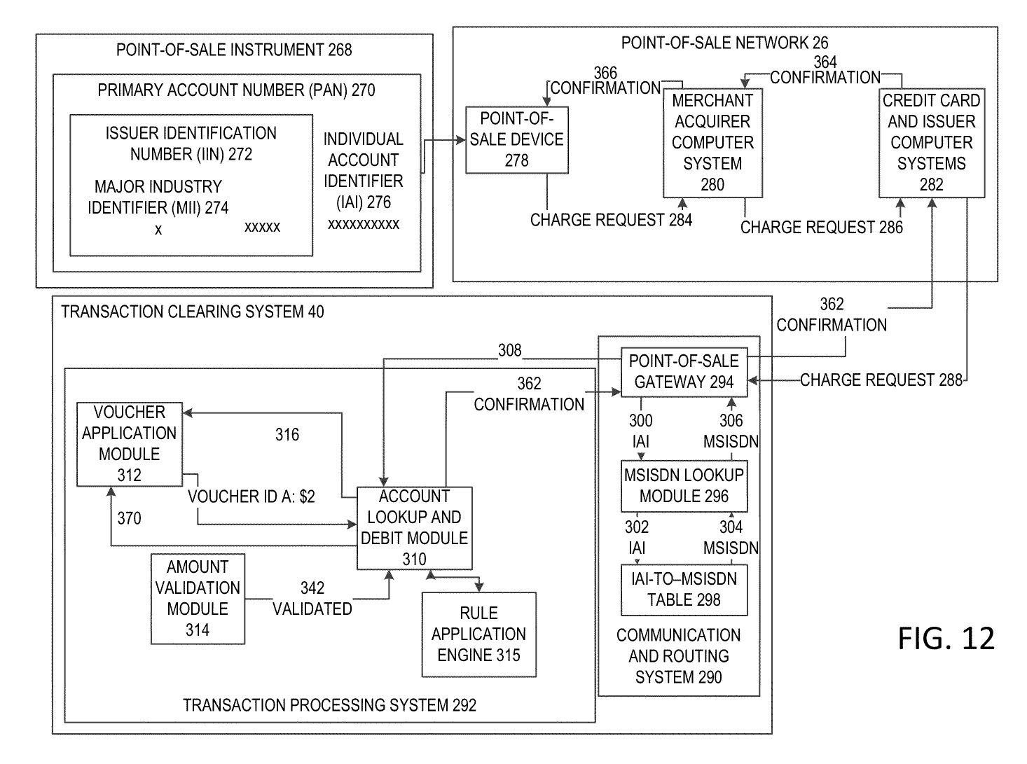

Referring to FIG. 12, the consumer uses a single point-of-sale instrument 268 to pay for an item that the consumer wishes to purchase. The point-of-sale instrument 268 may for example be a credit card, a bank card or a Near Field Communication (NFC) device. The point-of-sale instrument 268 includes a single 16 digit primary account number (PAN) 270. The first six digits of the PAN 270 are an issuer identification number (IIN) 272. The first digit of the IIN 272 is a major industry identifier (MII) 274. The last ten digits of the PAN 270 comprise an individual account identifier (IAI) 276.

The point-of-sale network 26 includes a point-of-sale device 278, a merchant acquirer computer system 280, and a credit card and issuer computer systems 282.

The consumer uses the point-of-sale instrument 268 to communicate with the point-of-sale device 278. The point-of-sale device 278 receives the PAN 270 from the point-of-sale instrument 268. In the case where the point-of-sale instrument 268 is a credit card or a bank card, the PAN 270 is located on a magnetic strip and the point-of-sale device 278 is a device that has a magnetic strip reader. In the example where the point-of-sale instrument 268 is an NFC device, the point-of-sale device 278 communicates with the point-of-sale instrument 268 through electromagnetic waves to receive the PAN 270.

The point-of-sale device 278 transmits a charge request 284 to the merchant acquirer computer system 280. The charge request 284 includes the PAN 270, the terminal number of the point-of-sale device 278. The point-of-sale device 278 also transmits the total price of all the items over the internet. Although not shown, the charge request 284 also includes a merchant account ID 130 to determine a merchant account 36 to which the point-of-sale device 278 belongs to.

The merchant acquirer computer system 280 then transmits a charge request 286 to the credit card and issuer computer systems 282. The charge request 286 includes the same data as the charge request 284. The charge request 286 also includes a merchant category code that is provided by the merchant acquirer computer system 280. Different merchant category codes are used for different merchant types, e.g. apparel, restaurant, groceries etc. The point-of-sale network 26 has a number of different credit card and issuer computer systems 282 and the merchant acquirer computer system 280 utilizes the IIN 272 to route the charge request 286 to the appropriate credit card and issuer computer systems 282. The credit card and issuer computer systems 282 then transmit a charge request 288 to the transaction clearing system 40. The charge request 288 includes the same data as the charge request 286. The credit card and issuer computer systems 282 utilize the PAN 270 to route the charge request 288 to the transaction clearing system 40.

The transaction clearing system 40 includes a communication and routing system 290 and a transaction processing system 292. The communication and routing system 290 communicates bidirectionally with the credit card and issuer computer systems 282 and communicates bidirectionally with the transaction processing system 292.

The communication and routing system 290 includes a point-of-sale gateway 294, an MSISDN lookup module 296 and an IAI-to-MSISDN table 298. The point-of-sale gateway 294 receives the charge request 288 from the credit card and issuer computer systems 282. At 300, the point-of-sale gateway 294 provides the IAI 276 in the PAN 270 received in the charge request 288 to the MSISDN lookup module 296. At 302, the MSISDN lookup module 296 utilizes the IAI 276 as an input lookup into the IAI-to-MSISDN table 298. At 304, the MSISDN lookup module 296 receives a MSISDN from the IAI-to-MSISDN table 298. A plurality of IAIs is stored within the IAI-to-MSISDN table 298, each with a respective associated MSISDN. The MSISDN received at 304 corresponds to a specific IAI 276 provided at 302. At 306, the point-of-sale gateway 294 receives the MSISDN from the MSISDN lookup module 296. At 308, the point-of-sale gateway 294 provides a data set to the transaction processing system 292, including the MSISDN retrieved from the IAI-to-MSISDN table 298 via the MSISDN lookup module 296, the terminal number received in the charge request 288, the item identifiers and associated amounts received in the charge request 288, and the respective merchant account ID 130 received in the charge request 288.

The transaction processing system 292 includes an account lookup and debit module 310, a voucher application module 312, an amount validation module 314 and a rule application engine 315.

The account lookup and debit module 310 receives the data set provided at 308 from the point-of-sale gateway 294. At 316, the account lookup and debit module 310 provides a data set to the voucher application module 312, including the MSISDN terminal number, amount and merchant account ID. Referring again to FIG. 9, at 318 the voucher application module 312 provides a data set to the voucher management system 42 corresponding to the data set received from the account lookup and debit module 310 at 316. The purpose of the voucher application module 312 is to determine if, and if so, which voucher discounts may apply to the items identified in the data set received at 316. The voucher redemption system 198 includes a voucher lookup module 320, a voucher availability module 322 and a voucher cancel module 324.

The voucher lookup module 320 receives the data transmitted at 318 from the voucher application module 312. The voucher lookup module 320 then uses the data received at 318 to determine whether the data matches the data in the voucher entries 168. In each case, both the merchant account ID and the terminal number received in the data 318 are used to determine which ones of the voucher entries 168 have merchant account ID's 130 and matching terminal numbers 170.

The voucher lookup module 320 subsequently retrieves a set of data from an identified voucher entry 168, including the discount 174, in the present example $2, the voucher ID 184 and the total number available 176. The voucher lookup module 320 then makes a determination whether the total number available 176 of the respective voucher entry 168 is more than zero, in which case and only in that case, is the voucher entry 168 still valid. The voucher lookup module 320 also retrieves the merchant account ID 130. For purposes of further discussion, the voucher ID's 184 of the identified voucher entry 168 is still valid and referred to herein as “voucher ID's B.”

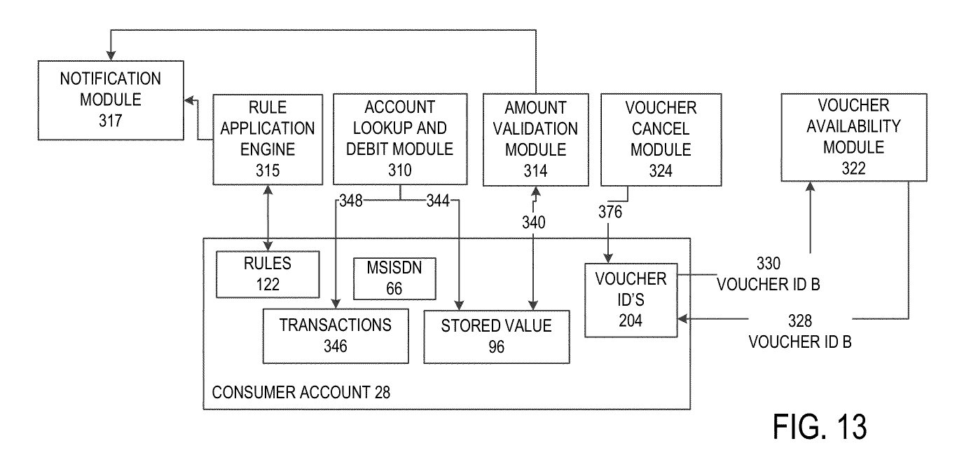

The voucher lookup module 320 at 326 submits the voucher ID of the identified voucher entry 168, now referred to as “voucher ID B” to the voucher availability module 322. Referring now to FIG. 13, the voucher availability module 322 determines whether voucher ID B is still valid within the voucher ID's 204 of the respective consumer account 28. Voucher ID B may for example not be valid, either because it has previously been used or the particular consumer account 28 having the MSISDN 66 has not been targeted by a merchant. In the present example, voucher ID B is found within the voucher ID's 204 and is determined to be valid. At 330, voucher ID B that is determined to be valid is returned to the voucher availability module 322. Referring again to FIG. 9, the voucher lookup module 320 retrieves voucher ID B from the voucher availability module 322 because it is valid.

At 334 the voucher lookup module 320 submits the voucher ID B together with its associated discount, in the present example $2, in a data set to the voucher application module 312. The data set received at 334 by the voucher application module 312 also includes the respective merchant account ID 130 retrieved by the voucher lookup module 320. The voucher application module 312 then calculates a discounted amount based on the amounts received in the charge request minus the discount found for voucher entry (ID?) B. Referring again to FIG. 12, the voucher application module 312 submits the voucher ID B, the discounted amount and the respective merchant account ID 130 to the amount validation module 314.

Referring again to FIG. 13, at 340, the amount validation module 314 determines whether the discounted amount is less than the stored value 96. If the discounted amount is less than the stored value 96, then the amount validation module 314 validates the transaction to the account lookup and debit module 310 in FIG. 9. If the amount validation module 314 at 340 determines that the discounted amount is not less than the stored value 96, then the amount validation module 314 does not validate the transaction at 342 to the account lookup and debit module 310.

Only if the transaction is validated at 342 at the account lookup and debit module 310 and absent any rules for expense tracking does the account lookup and debit module 310 proceed at 344. At 344, the account lookup and debit module 310 utilizes the MSISDN received at 308 to identify the respective consumer account 28 having a MSISDN 66 matching the MSISDN received at 308.

The account lookup and debit module 310 then reduces the stored value 96 of the respective consumer account 28 having the respective MSISDN 66 by the discounted amount. The consumer account 28 also has a set of previous transactions 346. At 348, the account lookup and debit module 310 records the respective transaction within the transactions 346.

Referring again to FIG. 13, the voucher cancel module 324 proceeds at 376 to cancel the respective voucher ID's from the voucher ID's 204 in the consumer account 28. In one example, there may be only one voucher ID B among the voucher ID's 204 and only the single voucher ID B is cancelled. In another example, the voucher ID may have two or more numbers associated therewith, and only a single number is deducted from the numbers for voucher ID B, such that further numbers of the voucher ID are available until the number reaches zero.

As mentioned, the transaction is recorded within the transactions 346. Referring again to FIG. 2, the transaction viewing module 220 downloads the transactions 346 of FIG. 13 as transactions 380 and displays the transactions 380 as transactions 382 within the Interface 210.

Voucher entries have been used by way of example to illustrate offers and the way that they are redeemed. The voucher entries may for example correspond to item level discounts. Alternatively, basket level discounts may be provided wherein a discount is given based on an entire purchase of a plurality of items as opposed to individual items of the purchase. It may also be possible that offers may be extended that are not redeemable at server level for any discounts, such as coupons that can be redeemed at a point of sale or advertisements.

### 5). Rules for Expense Tracking

As mentioned with respect to FIG. 2, a consumer can enter a rule 230 into the interface 210, which is received by the consumer account management module 214 as a rule 244. In FIG. 3, the rule 244 is received as a rule 120 within the consumer account management system 34. The rules storing module 90 then stores the rule 120 as a rule 122 in the consumer account 28. Access to the rules storing module 90 by the mobile device 24 in FIG. 2 to store the rule 122 is only permitted upon successful login based on the login information of the password 74 and the MSISDN 76 through the login module 70.

As further shown in FIG. 12, the rule application engine 315 is connected to the account lookup and debit module 310. The account lookup and debit module 310 and the rule application engine 315 can communicate bidirectionally with one another. The rule application engine 315 can receive data from the account lookup and debit module 310 indicating that the charge request 308 has been received and whether it has been validated at 342 by the amount validation module 314. The rule application engine 315 can also notify the account lookup and debit module 310 to stop the transaction before transmitting the confirmation 362. The confirmation 362 will thus not be sent even though the amount validation module 314 has provided the validation 342 to the account lookup and debit module 310.

As shown in FIG. 13, both the amount validation module 314 and the rule application engine 315 are connected to a notification module 317 forming part of the server computer system 12 of FIG. 1. The rule application engine 315 is also connected to the rule 122 in the consumer account 28.

As previously mentioned, the amount validation module 314 compares the stored value 96 with the charge amount in the charge request 308 as modified by the voucher application module 312, wherein the stored value 96 is (i) only reduced if the stored value 96 is at least as much as the charge amount and (ii) not reduced if the stored value 96 is less than the charge amount, and transmits the confirmation 362 (i) to accept the charge request only if the store value 96 is at least as much as the charge amount and (ii) to deny the charge request if the stored value 96 is less than the charge amount. As further illustrated in FIG. 13, the amount validation module 314 initiates action by the notification module 317 to transmit an Short Message Service (SMS) message to the mobile device 24 in FIG. 2. The mobile device 24 includes a notifications module 300 that receives the notification as a notification 302. The notification 302 received by the notifications module 300 is displayed as a notification 304 within the interface 210.

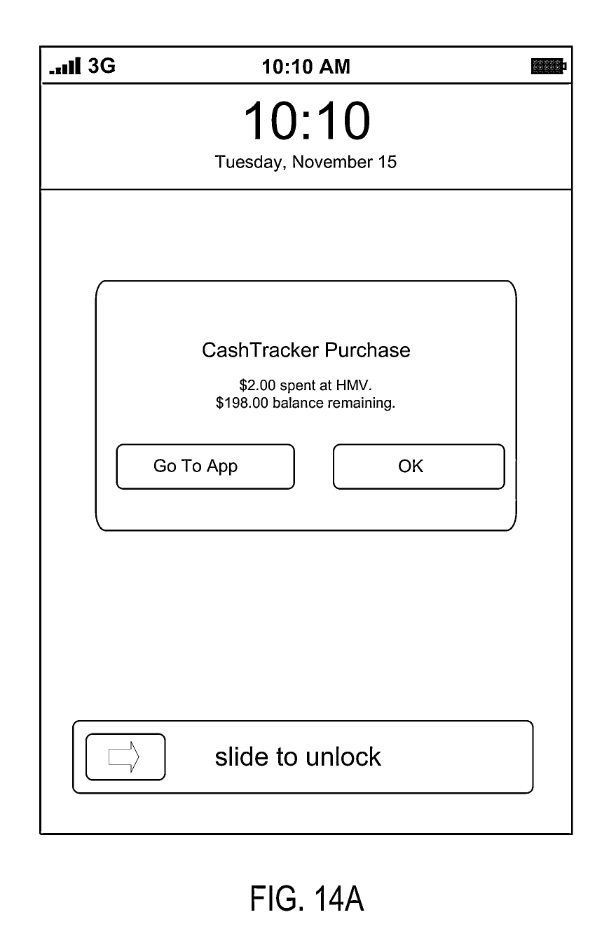

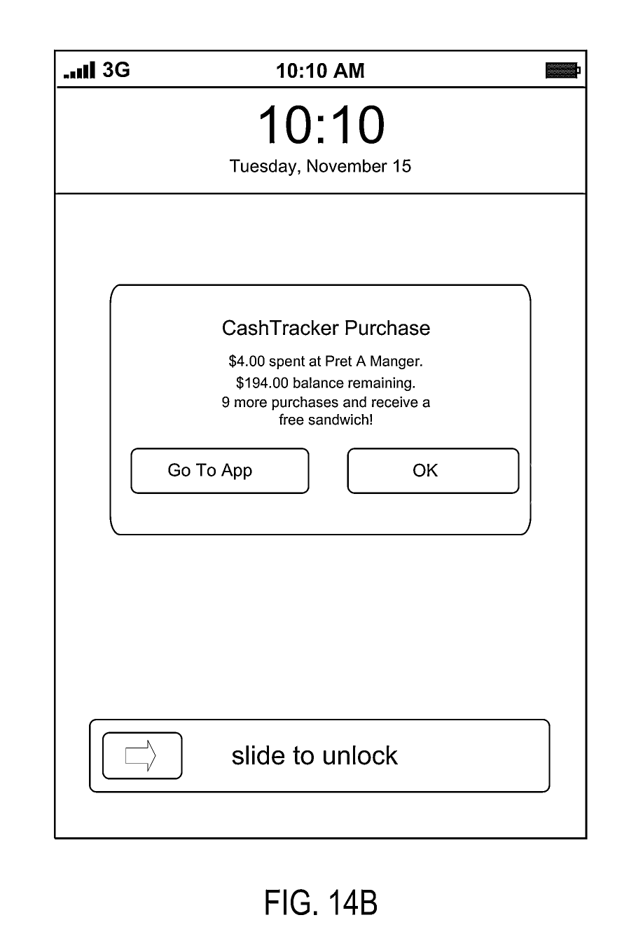

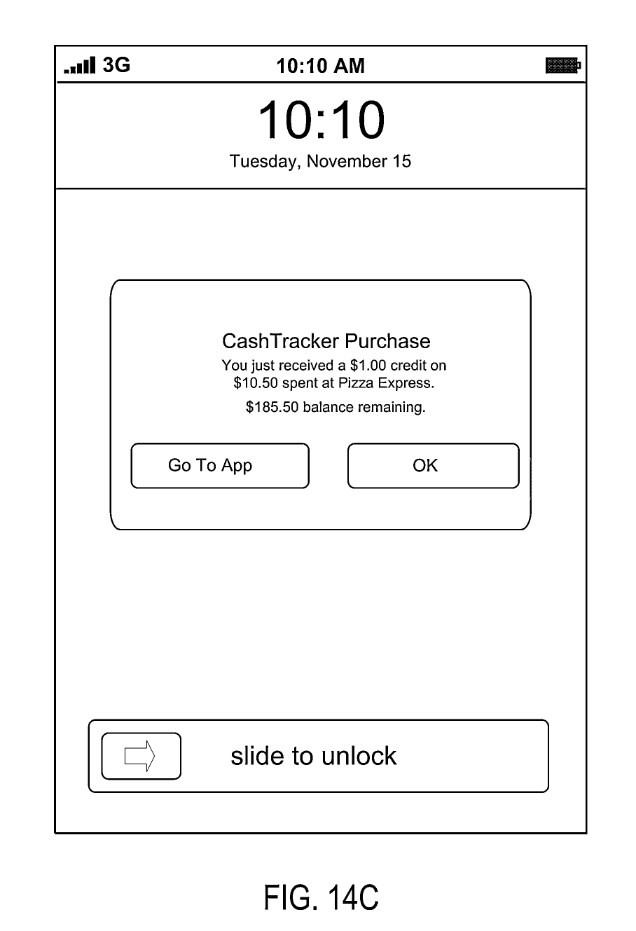

In FIG. 14A, the notification 304 received in the interface 210 of FIG. 2 is displayed to the consumer. In the present example, the charge amount was $2.00 and the stored value 96 in FIG. 3 has been reduced from $200.00 to $198.00. The notification 304 also has a button “OK” for clearing the notification 304, and a button “Go To App” that will open the view of FIG. 10. In FIG. 14B, a notification 304 is received and displayed to the consumer indicating a charge of $4.00, bringing the stored value 96 to a balance of $194.00. The notification 304 also indicates text displayed to the consumer indicating that 9 more purchases will result in a discount for a free sandwich. In FIG. 14C, a notification 304 is received and displayed to the consumer, indicating a charge of $10.50 and that a credit of $1.00 has been applied to bring the balance of the stored value 96 to $185.50.

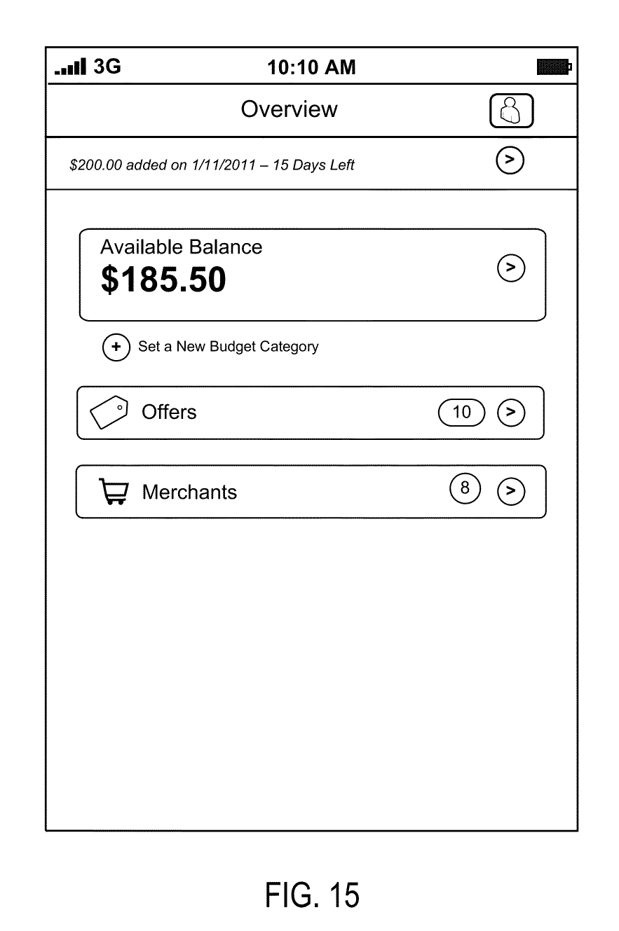

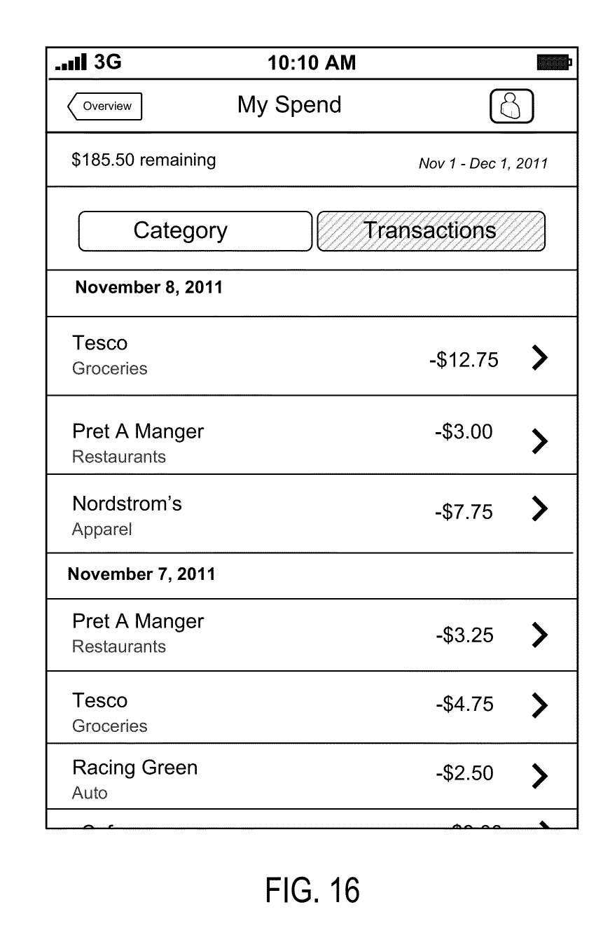

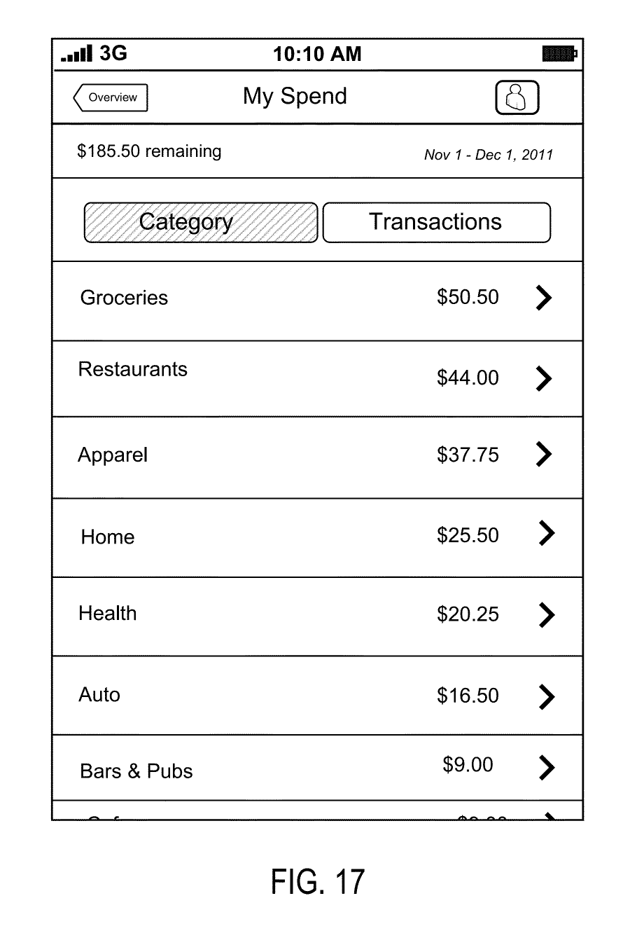

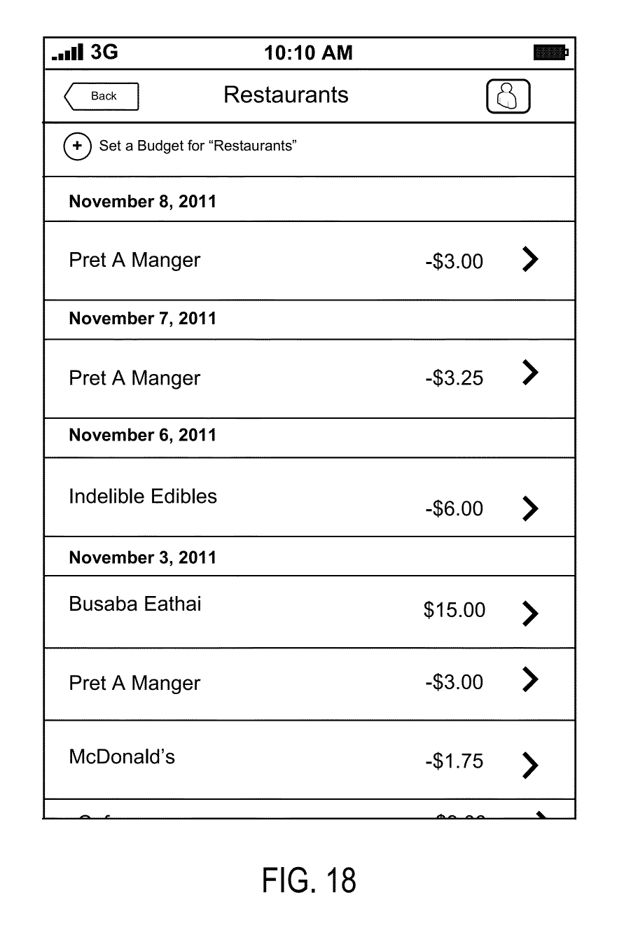

Should the consumer then open the mobile application 208 in FIG. 2, a view such as in FIG. 15 is displayed to the consumer. The view in FIG. 15 includes the balance of the stored value 96 of $185.50 and also links to Offers and Merchants. The view in FIG. 15 is thus an updated view of the view in FIG. 10. Should the consumer select the link next to the Available Balance, the consumer is taken to the view of FIG. 16 wherein details of all transactions are displayed. The transactions displayed in FIG. 16 thus correspond to the transactions 382 in FIG. 2. FIG. 16 also provides a link for the consumer to view categories of transactions. Should the consumer select the link for categories, a view such as in FIG. 17 is displayed to the consumer. Should the consumer then select one of the categories, for example the category for “Restaurants”, a view such as in FIG. 18 is displayed. In FIG. 18, transactions categorized as “Restaurants” are displayed to the consumer.

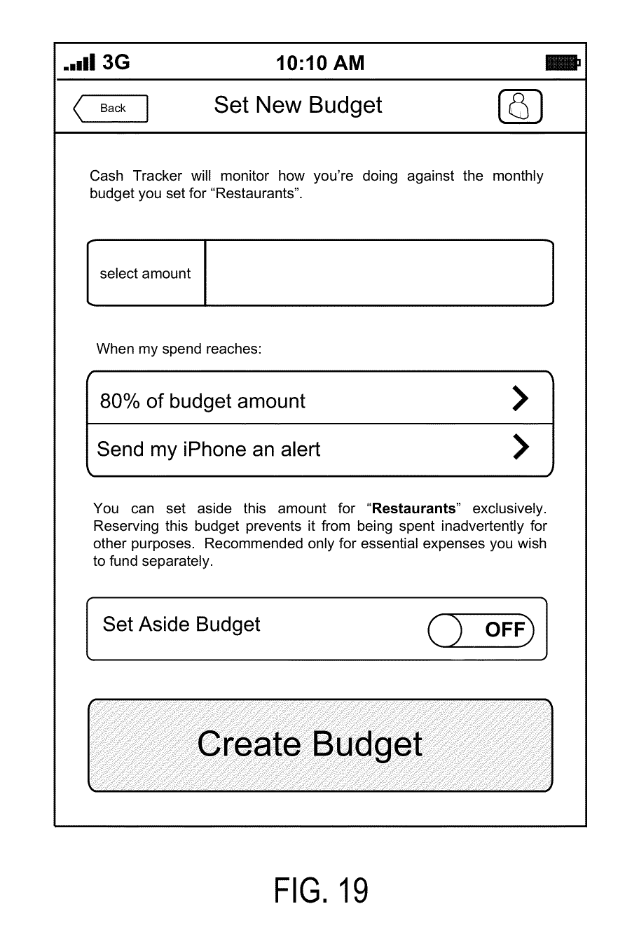

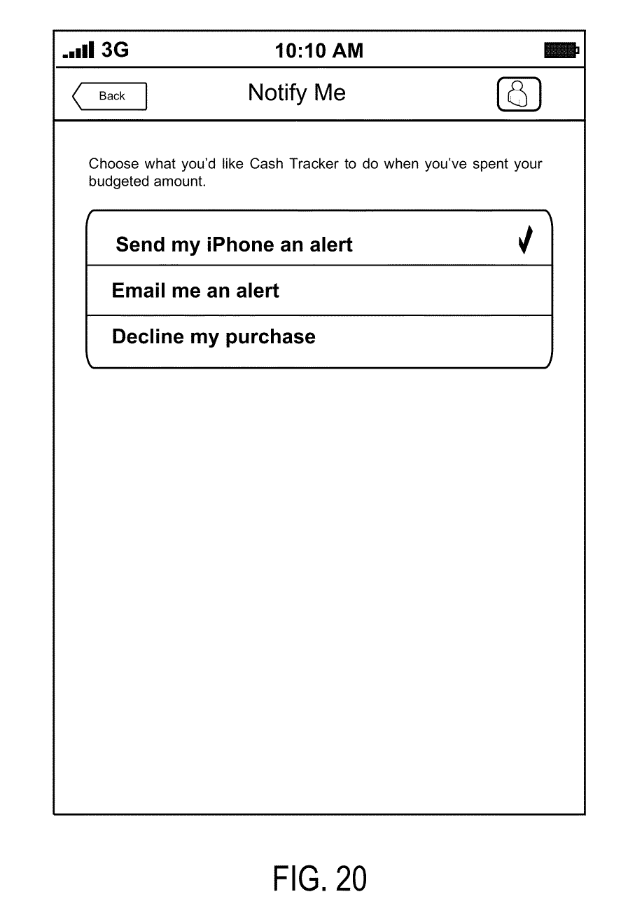

FIG. 18 also includes a link for the consumer to set a budget for “Restaurants.” Selection of the link opens a view such as shown in FIG. 19. The view in FIG. 19 can also be indirectly obtained by selecting a similar link in the view of FIG. 15. In FIGS. 19 and 20, the consumer then sets parameters for the rules 230 and 244 of FIG. 2 and rule 122 of FIGS. 3 and 13. The consumer can select an amount, for example $50.00. The consumer can then select an action to be taken when the amount or a percentage of the amount is reached. In the present example, the consumer has selected that if 80% of the $50.00 is reached, an alert is sent to the consumer's mobile device. The 80% limit can be adjusted to for example 90%, 100%, 110% or 120%.

A setting is also provided for a “Set Aside Budget.” If the “Set Aside Budget” is off, then the stored value 96 is permitted to run down to $0. The stored value 96 can thus be less than the remainder of the budget. By way of example, the remaining budget for “Restaurants” can be $35.00 and the stored value 96 can be at $20.00.

If the “Set Aside Budget” is on, then the stored value 96 can only be reduced down to the remainder of the budget. If for example, if the budget for “Restaurants” has run down from $50.00 to $35.00, then the stored value 96 will not permitted to run down past $35.00. The remainder of the “Restaurants” budget will thus always be usable.

In FIG. 20, the consumer can select what action is to be taken when the budget or the percentage of the budget is reached. The consumer can select any one, two or all of the options. For the first two options, the rule application engine 315 in FIG. 13, after reading the rule 122, initiates action by the notification module 317 to send a notification via SMS to the mobile device 24 or as an email to an email address. The identifier used for transmitting an SMS is the mobile number entered by the consumer in FIG. 4B and stored in the consumer account 28. The identifier used for sending the email is the email address entered by the consumer in FIG. 4C and stored in the consumer account 28. If the third option is selected, the rule application engine 315 in FIG. 12 notifies the account lookup and debit module 310 to not proceed with the transaction. The account lookup and debit module 310 will thus not send the confirmation 362 or will send a decline message instead. In FIG. 13, the account lookup and debit module 310 will not reduce the stored value 96 at 344 and will not record the transaction at 348 within the transactions 346. By contrast, if any of the options in FIG. 20 is not selected, the action will not be taken by the rules application engine 315.

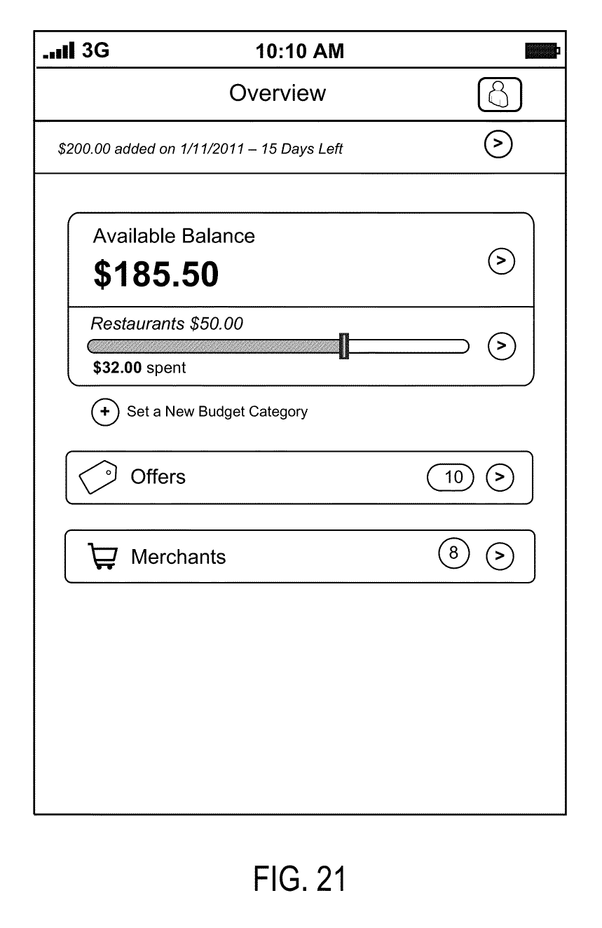

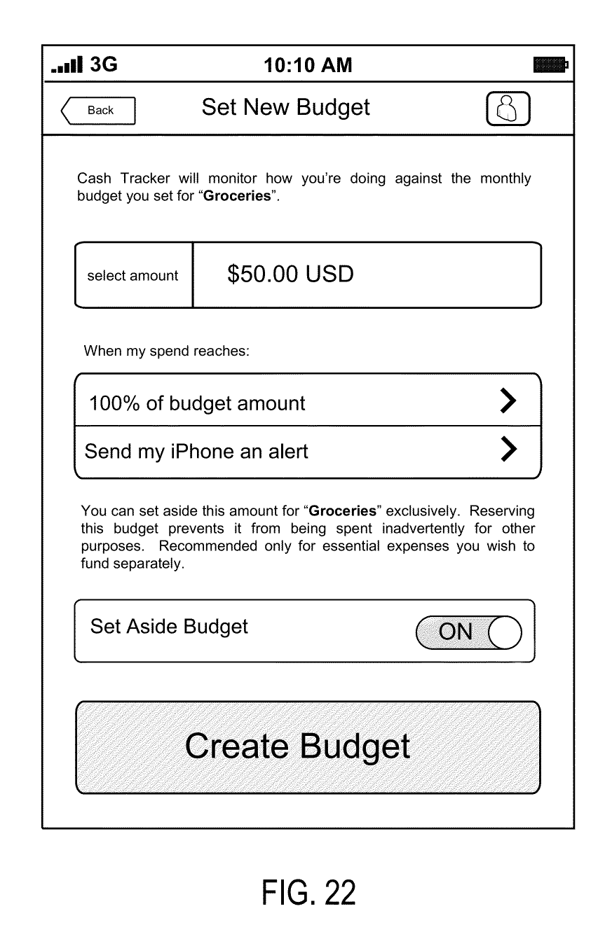

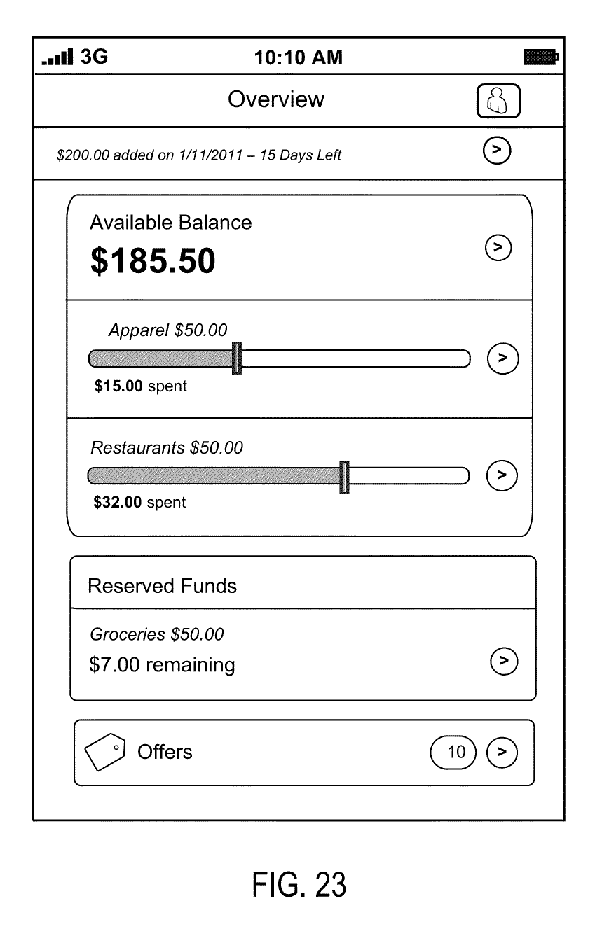

In FIG. 21, the home screen of FIG. 15 has been modified to include the budget category for “Restaurants” which is not a “Set Aside Budget.” In FIG. 22, the consumer enters a further budget for “Groceries” and designates the budget as a “Set Aside Budget.” FIG. 23 shows the “Set Aside Budget” as a reserve fund, and also shows a further budget category created by the consumer for “Apparel.”

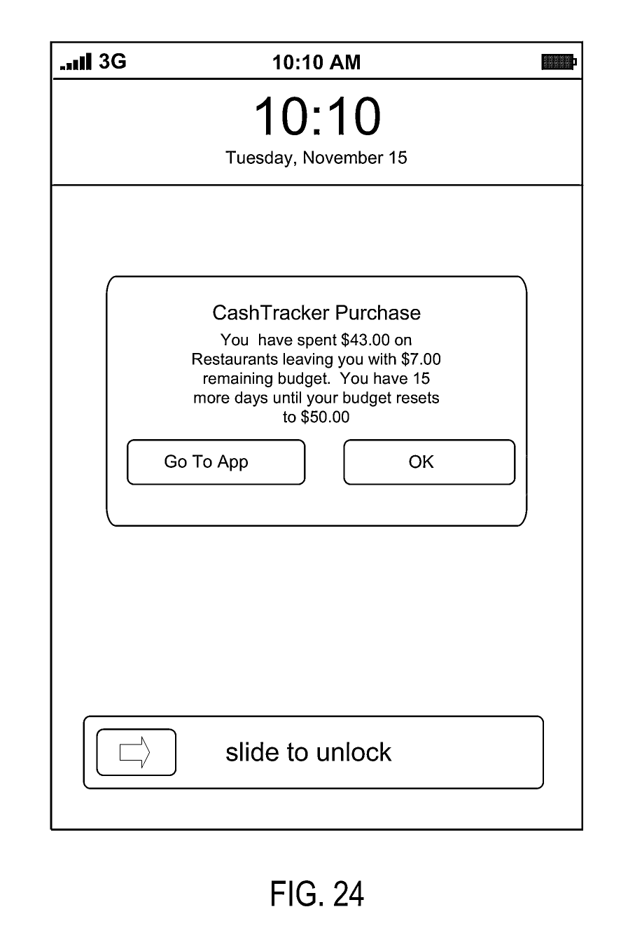

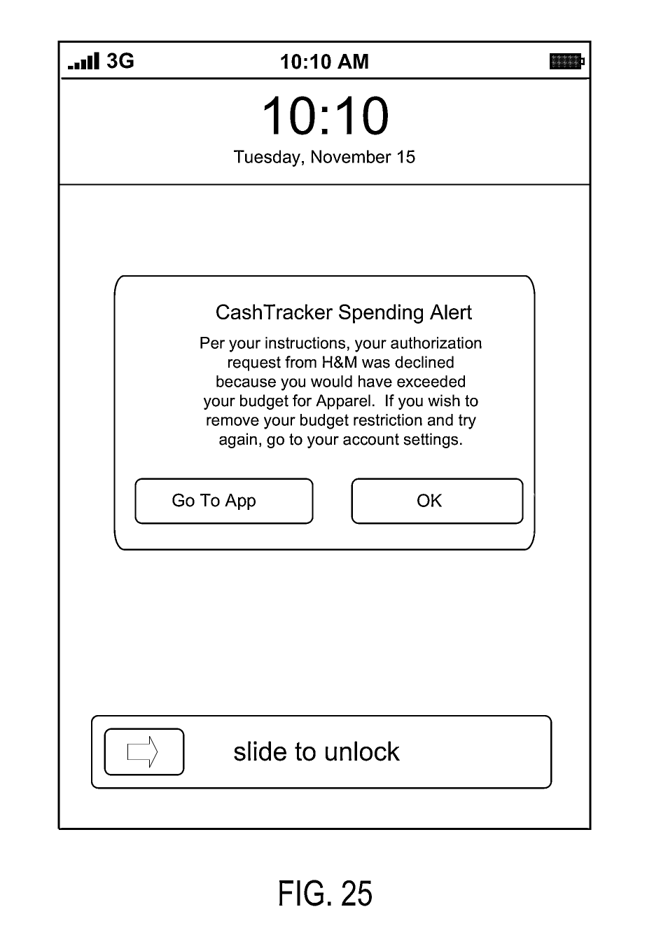

FIG. 24 shows an example of a message that is received and displayed to the consumer indicating a spend and a reduction in a budget category. FIG. 25 is an example of a message that is transmitted and received for viewing by the consumer to indicate that a transaction that has been declined by the rules application engine 315 in FIGS. 12 and 13, based on a rule set by the consumer within the consumer account 28.

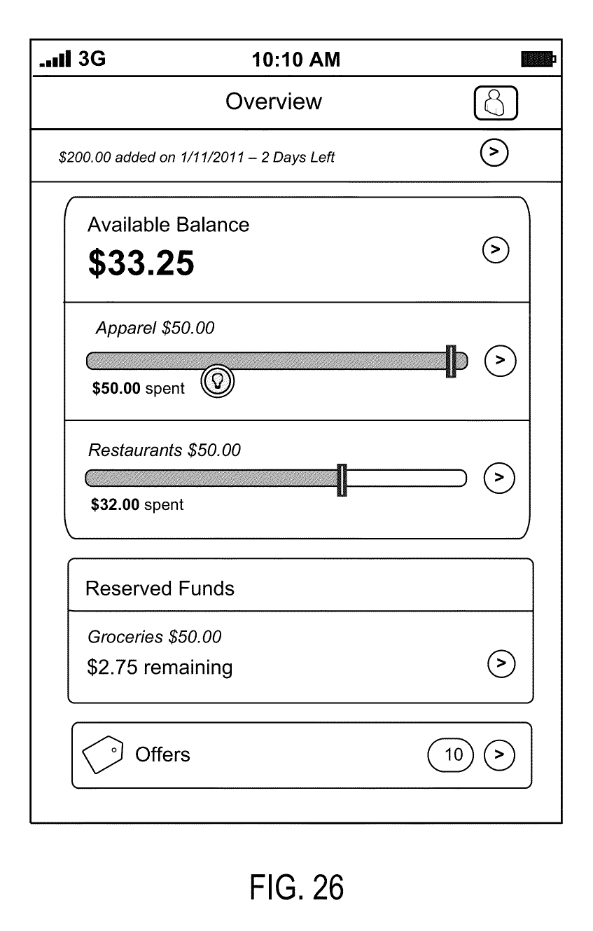

FIG. 26 shows the same view of FIG. 23 after further transactions have affected the stored value 96 and the budgets that have been created. In the views of FIGS. 10, 15, 21, 23 and 26, an indication is given to the consumer of how many days are left before the stored value 96 and budgets reset. The stored value 96 and budgets typically reset on the same day of every month.

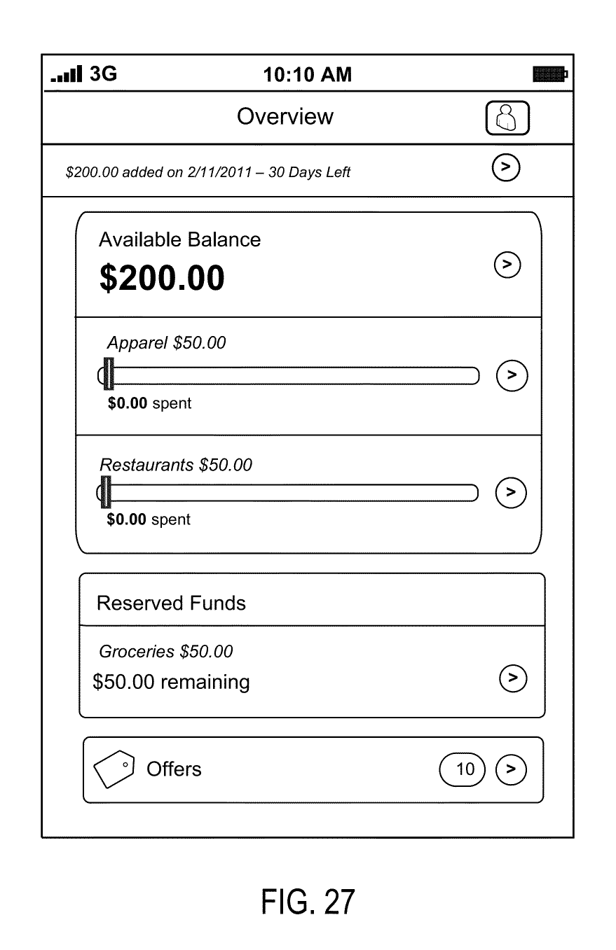

FIG. 27 illustrates a view that is displayed after the stored value 96 and budgets reset. The stored value 96 has reset to its original ceiling value. Referring to FIG. 3, the stored value 96 has been replenished using the automatic top-up execution module 88 at funding module 82. In FIG. 27, the categories for “Apparel,” “Restaurants,” and “Groceries” have all been reset to the original values.

The rules application engine 315 thus compares the budget amount stored within the rule 122 with the charge amount and the rules application engine 315 then reduces the budget amount with the charge amount. If the rule calls for declining the transaction, then the rules application engine 315 (i) only reduces both the stored value 96 and the budget amount if the budget amount is at least as much (or within the percentage range selected by the consumer,) of the charge amount and (ii) does not reduce the stored value 96 or the budget amount if the budget amount is less than the charge amount, and the account lookup and debit module 310 transmits the confirmation 362 (i) to accept a charge only if the budget amount is at least as much as the charge amount and (ii) to deny the charge request if the budget amount is less than the charge amount. The categories of the budgets are, in each case, compared to the merchant category codes provided by the merchant acquirer computer system 280 in FIG. 12 and transmitted by way of the charge requests 286 and 288 to the transaction processing system 40.

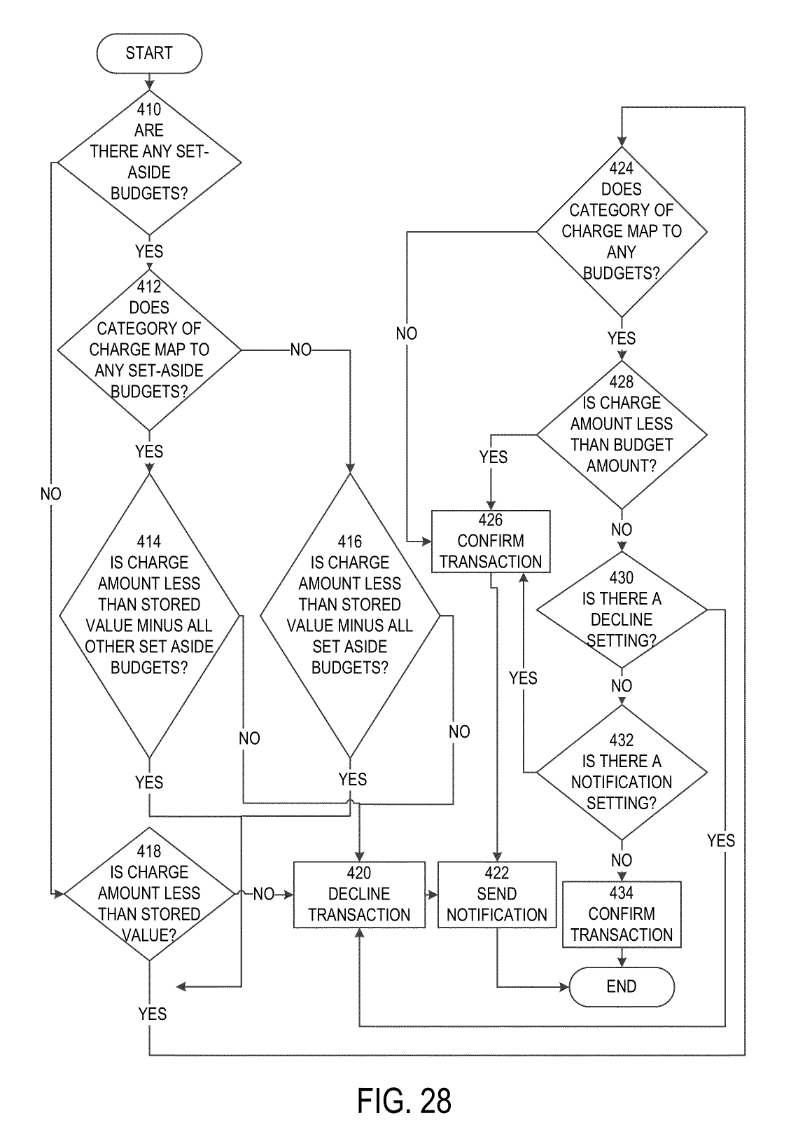

FIG. 28 illustrates how transactions are processed using the rule application engine 315 of FIGS. 12 and 13. At 410 a determination is made whether there are any Set Aside Budgets. If there are any Set Aside Budgets then, at 412 a determination is made whether the category (merchant category code) of the charge maps to any Set Aside Budgets. If the answer to 412 is Yes, then at 414 a determination is made whether the charge amount is less than the stored value 96 minus all other Set Aside Budgets. If the answer to 412 is No, then at 416 a determination is made whether the charge amount is less than the stored value 96 minus all Set Aside Budgets.

If the determination at 410 is that there are no Set Aside Budgets then at 418, a determination is made whether the charge amount is less than the stored value 96. If the determination made at 414, 416 or 418 is No, then at 420 the transaction is declined. Following 420, the appropriate notification is sent at 422 as described with reference to FIGS. 14A, B and C and FIGS. 24 and 25.

If the determination at 414, 416, or 418 is Yes, then at 424 a determination is made whether the category (merchant category code) of the charge maps to any budgets. If the determination at 424 is No, then at 426 the transaction is confirmed and the appropriate notification is transmitted at 422.

If the determination at 424 is Yes, then at 428 a determination is made whether the charge amount is less than the respective budget amount. If the determination at 428 is Yes, then the charge is confirmed at 426 and the appropriate notification is transmitted at 422.

If the determination at 428 is No, then at 430 a determination is made whether there is a decline setting as described with reference to FIG. 20. If the determination at 430 is Yes, then the transaction is declined at 420 and the appropriate notification is transmitted at 422. If the determination at 430 is No, then at 432 a determination is made whether there is a notification setting as described with reference to FIG. 20. If the determination at 432 is Yes, then the transaction is confirmed at 426 and the appropriate notification is transmitted at 422. If the determination at 432 is No, then the transaction is confirmed at 434 and no notification is transmitted.

### 6). Computer System

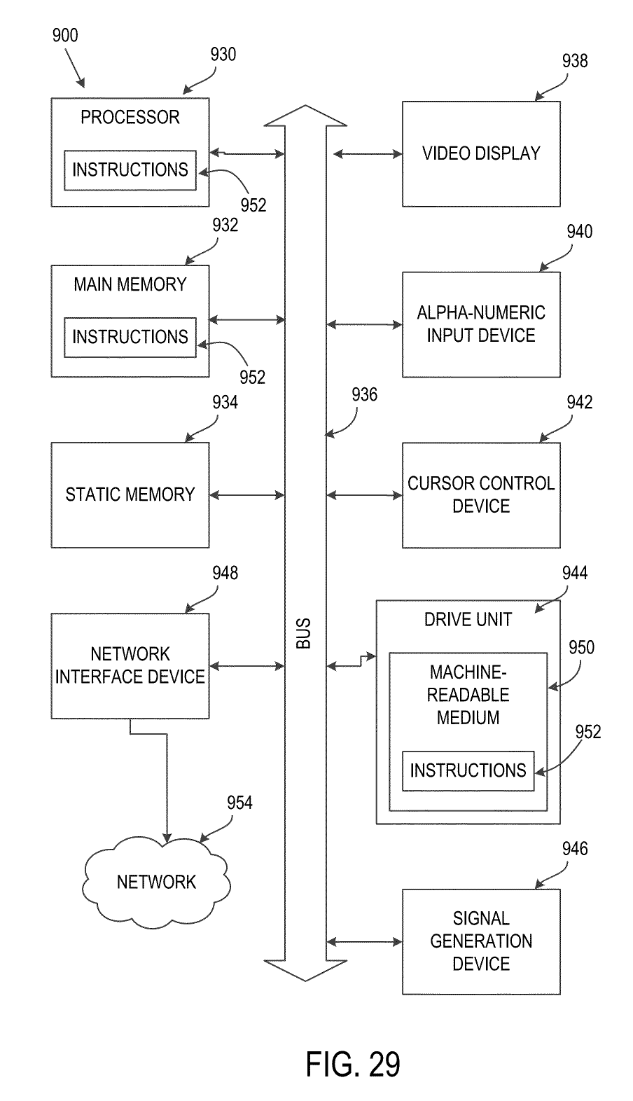

FIG. 29 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal display (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While the instructions 952 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

### 7). Mobile Device

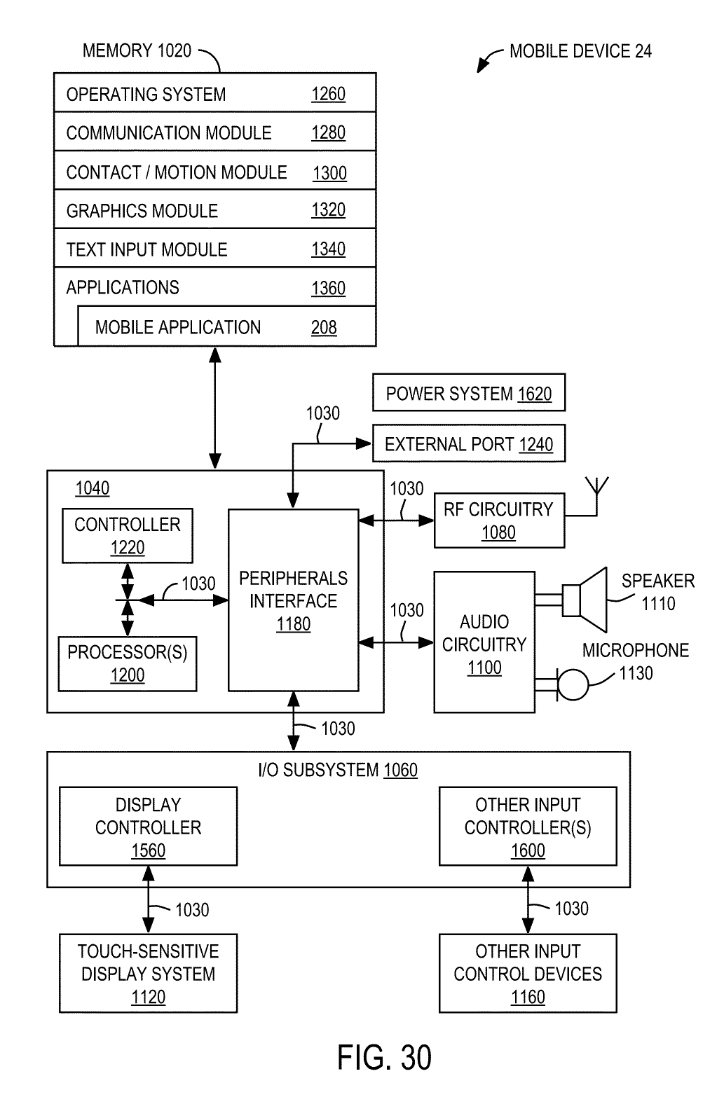

FIG. 30 is a block diagram illustrating the mobile device 24, illustrating a touch-sensitive display 1120 or a “touch screen” for convenience. The mobile device 24 includes a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 30 may be implemented in hardware, software or a combination of both hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the mobile device 24, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the mobile device 24 and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the mobile device 24. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the mobile device 24, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the mobile device 24 on or off. The touch screen 1120 is used to implement virtual or soft buttons and one or more soft keyboards.

The touch-sensitive touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The mobile device 24 also includes a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), FIREWIRE, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include the mobile application 208.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer system for managing electronic transactions, comprising:
a server computer system including:
a processor;
a computer-readable medium connected to the processor;
a network interface device connected to the processor; and
a set of instructions on the computer-readable medium, the set of instructions being executable by the processor and including:
a data store;
a plurality of consumer accounts stored in the data store, each consumer account having a first consumer account identifier;
a rule stored in association the consumer account;
a communication and routing module that receives a charge request over the network interface device, the charge request including an charge amount and a second consumer account identifier and identifies a selected one of the consumer accounts by associating one of the first consumer account identifiers with the second consumer account identifier;
a rule application engine that retrieves the rule of the selected consumer account in response to receiving the charge request, and executes an action based on the rule.

2. The computer system of claim 1, wherein the set of instructions further includes:
a stored value in the consumer account;
a login module receiving login information from the consumer device over the network interface device;
a funding source storing module storing a funding source in the consumer account, access to the funding source storing module by the user computer system to store the funding source only being permitted upon successful login based on the login information, wherein the funding module routes the funding request based on the funding source;
a funding module transmitting a funding request to the consumer account funding infrastructure, the funding request including a credit value, receiving a top-up confirmation in response to the funding request from a consumer account funding infrastructure, and increasing the stored value based on the top-up instruction by the credit value; and
an account lookup and debit module that reduces the stored value of the selected consumer account based on the charge amount.

3. The computer system of claim 2, wherein the transaction processing system includes:
an amount validation module that compares the stored value with the charge amount, wherein the account lookup and debit module only reduces the stored value with the charge amount, wherein the stored value is (i) only reduced if the stored value is at least as much as the charge amount and (ii) not reduced if the stored value is less than the charge amount, and transmits a confirmation over the network interface device (i) to accept the charge request only reduced if the stored value is at least as much as the charge amount and (ii) to deny the charge request if the stored value is less than the charge amount.

4. The computer system of claim 3, wherein the rule calls for a notification to be sent, further comprising:
a notification module transmitting a message over the network interface device to the consumer device based on an identifier in the consumer account having the consumer account identifier, the message including the stored value after having been reduced by the charge amount.

5. The computer system of claim 2, wherein the set of instructions further includes:
an automatic top-up settings module receiving a first automatic top-up ceiling from the consumer device over the network interface device, and stores the first automatic top-up ceiling as a second automatic top-up ceiling in the consumer account;
an automatic top-up execution module determining when the stored value falls below an automatic top-up ceiling, and transmitting the funding request automatically on a predetermined day and when the stored value falls below the automatic top-up ceiling, the funding request being routed based on the funding source.

6. The computer system of claim 5, wherein the rule calls for a notification to be sent, further comprising:
a notification module transmitting a message the network interface device to the consumer device based on an identifier in the consumer account having the consumer account identifier, the message including the stored value after having been reduced by the charge amount and indicating on what predetermined day the funding request will be transmitted.

7. The computer system of claim 1, further comprising:
a login module receiving login information from the consumer device over the network interface device; and
a rules storing module receiving a rule from a consumer device and storing the rule in association the consumer account, access to the rules storing module by the consumer device to store the rule only being permitted upon successful login based on the login information.

8. The computer system of claim 7, wherein the rule is a budget rule with a budget amount and the rule application engine compares the budget amount with the charge amount, wherein the rules application engine only reduces the budget amount with the charge amount, wherein the budget amount is (i) only reduced if the budget amount is at least as much as the charge amount and (ii) not reduced if the budget amount is less than the charge amount, and the account lookup and debit module transmits a confirmation over the network interface device (i) to accept the charge request only if the budget amount is at least as much as the charge amount and (ii) to deny the charge request if the budget amount is less than the charge amount.

9. The computer system of claim 7, wherein the rules storing module stores a plurality of budget amounts, each for a separate category of expenses.

10. The computer system of claim 8, further comprising:
a notification module transmitting a message over the network interface device to the consumer device based on an identifier in the consumer account having the consumer account identifier, the message including the budget amount after having been reduced by the charge amount.

11. The computer system of claim 10, wherein the notification indicates on what predetermined day the budget will be increased to the budget amount set by the consumer.

12. The computer system of claim 1, wherein the set of instructions further includes:
a plurality of merchant accounts stored in the data store, each merchant account having a merchant account identifier;
an interface for the merchant account, the interface for the merchant account being transmitted over the network interface device to a merchant computer system, the interface for the merchant account allowing for entry of a merchant offer into the merchant interface and transmission of the merchant offer, the merchant offer being received from the merchant computer system over the network interface device, the merchant offer being stored in the data store in association with the merchant account having the respective merchant account identifier;
a login module receiving login information from the consumer device over the network interface device; and
the merchant offer being transmitted over the network interface device to the consumer device, access to the merchant offer only being permitted upon successful login based on the login information.

13. The computer system of claim 12, wherein the merchant offer is a voucher entry including a discount, the instructions further comprising:
a voucher redemption system identifying a selected one of the voucher entries, wherein the transaction processing system includes an account lookup and debit module that adjusts the first charge amount to a second charge amount that is less than the first charge amount based on the discount of the selected voucher entry, and processes the second charge amount based on the account detail of the selected consumer account.

14. A computer-based method of managing electronic transactions, comprising:
storing, with a processor, a plurality of consumer accounts in a data store, each consumer account having a first consumer account identifier;
storing a rule in association the consumer account;
receiving, with the processor, a charge request over the network interface device, the charge request including an charge amount and a second consumer account identifier;
identifying, with the processor, a selected one of the consumer accounts by associating one of the first consumer account identifiers with the second consumer account identifier;
retrieving, with the processor, the rule of the selected consumer account in response to receiving the charge request; and
executing, with the processor, an action based on the rule.

15. The method of claim 14, further comprising:
saving, with the processor, a stored value in the consumer account;
receiving, with the processor, login information from the consumer device over the network interface device
storing, with the processor, a funding source in the consumer account, the storing by the consumer device of the funding source only being permitted upon successful login based on the login information;
transmitting, with the processor, the funding request, the funding request being routed based on the funding source;
transmitting, with the processor, a funding request to the consumer account funding infrastructure, the funding request including a credit value,
receiving, with the processor, a top-up confirmation in response to the funding request from a consumer account funding infrastructure;
increasing, with the processor, the stored value based on the top-up instruction by the credit value; and
reducing, with the processor, the stored value of the selected consumer account based on the charge amount.

16. The method of claim 15, further comprising:
comparing, with the processor, the stored value with the charge amount, wherein the stored value is (i) only reduced if the stored value is at least as much as the charge amount and (ii) not reduced if the stored value is less than the charge amount;
transmitting, with the processor, a confirmation over the network interface device (i) to accept the charge request only reduced if the stored value is at least as much as the charge amount and (ii) to deny the charge request if the stored value is less than the charge amount; and

17. The method of claim 16, wherein the rule calls for a notification to be sent, further comprising:
transmitting a message the network interface device to the consumer device based on an identifier in the consumer account having the consumer account identifier, the message including the stored value after having been reduced by the charge amount.

18. The method of claim 15, further comprising:
receiving, with the processor, a first automatic top-up ceiling from the consumer device over the network interface device;
storing, with the processor, the first automatic top-up ceiling as a second automatic top-up ceiling in the consumer account;
determining, with the processor, when the stored value falls below an automatic top-up ceiling; and
transmitting, with the processor, the funding request automatically on a predetermined day and when the stored value falls below the automatic top-up ceiling, the funding request being routed based on the funding source.

19. The method of claim 18, wherein the rule calls for a notification to be sent, further comprising:
transmitting a message over the network interface device to the consumer device based on an identifier in the consumer account having the consumer account identifier, the message including the stored value after having been reduced by the charge amount and indicating on what predetermined day the funding request will be transmitted.

20. The method of claim 14, further comprising:
receiving, with the processor, login information from the consumer device over the network interface device; and
receiving, with the processor, a rule from a consumer device and storing the rule in association the consumer account, the storing by the consumer device of the rule only being permitted upon successful login based on the login information.

21. The method of claim 20, wherein the rule is a budget rule with a budget amount, further comprising:
comparing, with the processor, the budget amount with the charge amount, wherein the budget amount is (i) only reduced if the budget amount is at least as much as the charge amount and (ii) not reduced if the budget amount is less than the charge amount;
transmitting, with the processor, a confirmation over the network interface device (i) to accept the charge request only reduced if the budget amount is at least as much as the charge amount and (ii) to deny the charge request if the budget amount is less than the charge amount; and

22. The method of claim 21, further comprising:
storing a plurality of budget amounts, each for a separate category of expenses.

23. The method of claim 21, further comprising:
transmitting a message the network interface device to the consumer device based on an identifier in the consumer account having the consumer account identifier, the message including the budget amount after having been reduced by the charge amount.

24. The method of claim 23, wherein the notification indicates on what predetermined day the budget will be increased to the budget amount set by the consumer.

25. The method of claim 14, further comprising:
storing, with the processor, a plurality of merchant accounts in the data store, each merchant account having a merchant account identifier;
transmitting, with the processor, an interface for the merchant account over the network interface device to a merchant computer system, the interface for the merchant account allowing for entry of a merchant offer into the merchant interface and transmission of the merchant offer;
receiving, with the processor, the merchant offer from the merchant computer system over the network interface device;
storing, with the processor, the merchant offer in the data store in association with the merchant account having the respective merchant account identifier;
receiving, with the processor, login information from the consumer device over the network interface device;
transmitting, with the processor, the merchant offer over the network interface device to the consumer device, access to the merchant offer only being permitted upon successful login based on the login information.

26. The method of claim 25, wherein the charge amount in the charge request is a first charge amount, the merchant offer being a voucher entry including a discount, further comprising:
identifying, with the processor, a selected one of the voucher entries, wherein the processing of the charge request includes:
adjusting the first charge amount to a second charge amount that is less than the first charge amount based on the discount of the selected voucher entry;
processing, with the processor, the second charge amount based on the account detail of the selected consumer account.
